(19) United States
(12) Patent Application Publication
(10) Pub. No.: US 2009/0313232 A1
(43) Pub. Date: Dec. 17, 2009

(54) Methods and Apparatus to Calculate Audience Estimations

(76) Inventors: Thomas Austin Tinsley, New Port Richey, FL (US); Ian Bashaw, Parslppany, NJ (US)

Correspondence Address: Hanley, Flight & Zimmerman, LLC, 150 S. Wacker Dr. Suite 2100, Chicago, IL, 60606, US

(21) Appl. No.: 12/055,887

(22) Filed: Mar. 26, 2008

(51) Int. Cl. G06F 17/30; G06F 17/00

(52) U.S. Cl. 707/5; 715/234; 725/9; 707/E17.014; 707/3; 707/104.1; 707/E17.044

(57) ABSTRACT

Methods and apparatus for calculating audience estimations are disclosed. An example method includes identifying a subset of stored viewership data and allocating an observation array having a first-dimension index, each indicie of the index associated with one time-period of at least one household datapoint in the subset of stored viewership data. Additionally, the example method includes transferring the identified subset to the observation array, building an extensible markup language (XML) file based on at least one detected characteristic in the observation array, and generating a graphical user interface (GUI) based on the XML file for use with at least one query selection associated with the at least one detected characteristic.

### FIELD OF THE DISCLOSURE

The present disclosure relates generally to audience measurement, and, more particularly, to methods and apparatus to calculate audience estimations.

### BACKGROUND

Estimating an audience for one or more activities and/or characteristics typically involves acquiring large amounts of data from households. Such data acquisition occurs, in many instances, by way of a set-top box in each selected household to communicate a time-of-day associated with viewing a broadcast station selected by one or more users of the selected household. Additionally, the set-top box may communicate an indication of the identity of the person that selected the broadcast station, and/or the characteristics of the person (e.g., sex, age, general age category, etc.) that is watching the selected station during an associated time-of-day. Other characteristics of interest to a market researcher include details of the household itself, such as whether the selected household includes antenna-based television reception, basic cable television services, one or more television services capable of high-definition broadcasting, households having personal computers, households having high-speed internet access, etc.

In an effort to discern viewing behavior with a degree of confidence to allow general projections to a larger population, many households are typically instrumented with a set-top box and/or household monitoring equipment. In many instances, households are statistically selected based on sex, age, race, and/or an economic bracket, all of which may be generally referred to as household demographics. Generally speaking, as the number of households being monitored that match a demographic of interest increases, so does the confidence that projections of a larger viewing audience will be accurate.

However, as the number of households being monitored increases, the corresponding amount of collected data requires additional computing resources when the market researcher wishes to perform a query based on one or more characteristics (e.g., the number of households that viewed a particular station in which the viewers were female and between the ages of 25-34). Additionally, as the selection of desired characteristics to include in the query increases, so does the corresponding computing power to process the query in a reasonable amount of time.

### BRIEF DESCRIPTION OF THE DRAWINGS

FIG. 1 is a schematic diagram of an example system to calculate audience estimations.

FIG. 2 is a more detailed illustration of the audience estimator of FIG. 1.

FIG. 3 is a portion of an example viewership database accessed by the example system of FIGS. 1 and 2.

FIG. 4 is a portion of an example observation array of the example system of FIGS. 1 and 2.

FIGS. 5 and 7 are example graphical user interfaces (GUIs) for use with the example system of FIGS. 1 and 2.

FIGS. 6A-D are example global data structures accessed by the example system of FIGS. 1 and 2.

FIG. 8 is a portion of an example geography characteristics array generated by the example system of FIGS. 1 and 2.

FIG. 9 is a portion of an example household characteristics array generated by the example system of FIGS. 1 and 2.

FIG. 10 is a portion of an example persons characteristics array generated by the example system of FIGS. 1 and 2.

FIG. 11 is a portion of an example aggregate array generated by the example system of FIGS. 1 and 2.

FIGS. 12-16 are flow diagrams representative of example machine readable instructions that may be executed to implement the example systems of FIGS. 1 and 2.

FIG. 17 is a schematic illustration of an example processor system that may execute the machine readable instructions of FIGS. 12-16 to implement the example systems of FIGS. 1 and 2.

### DETAILED DESCRIPTION

Enabling a market researcher to enjoy relatively fast response times when performing a query of household viewership data is a challenge due to, in part, the vast amount of such viewership data collected. Typically, one or more databases are employed to store household viewership data, in which each household data entry contains a timestamp, an indication of the station selected during the timestamped period, an indication of the household identity, and/or an indication of which household member is watching the selected station. As the number of monitored households for a given geographic area increases, the computational resources required to process the large amounts of viewership data increases. Additionally, to improve projection confidence, market researchers usually seek a relatively larger number of samples and an increased sample rate (e.g., one data sample from a household every 15-minutes versus one data sample from a household every 1-minute), both of which further inundate computing resources.

Traditionally, database query engines (e.g., SQL Server®) generate and execute query commands and/or stored-procedures to sift through massive amounts of data so that a subset query of interest may be studied further. However, the methods and apparatus described herein seek to, in part, address the factors that negatively affect query performance. Generally speaking, the methods and apparatus described herein define a process to organize collected household data in a manner that does not require time-consuming text searching, and then further pre-processes the data in a manner that confines a user (e.g., a media researcher) to a finite number of characteristic permutations to query.

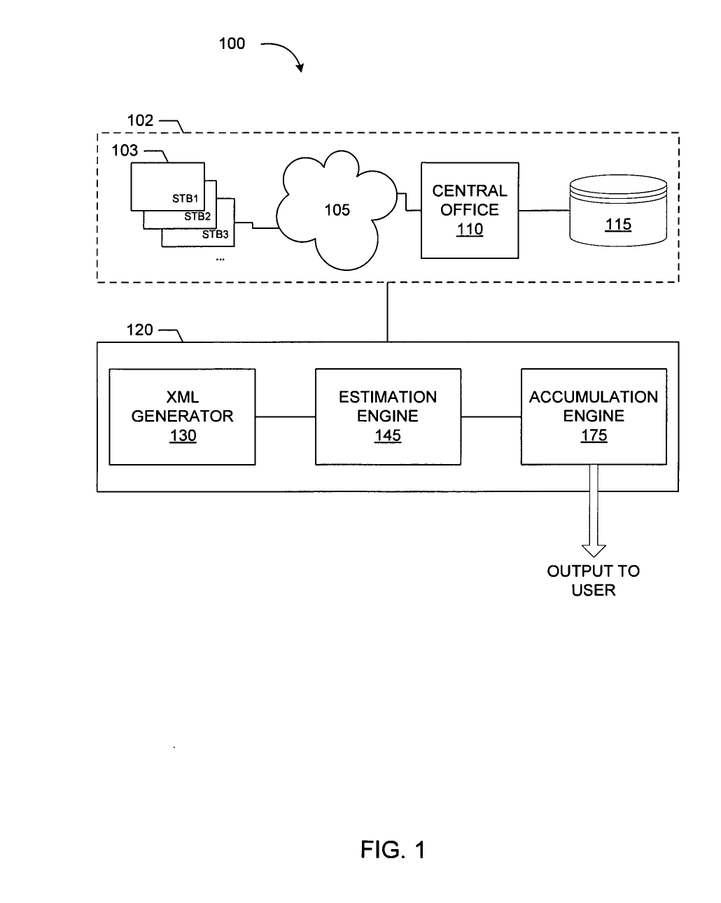

Referring to FIG. 1, an example system 100 to calculate audience estimations is shown. A household monitoring sub-system 102 operates to collect statistically significant household data prior to the calculation of audience estimations by the methods and apparatus described herein. In particular, the household monitoring sub-system 102 includes one or more set-top boxes (STBs) 103 within corresponding households and communicatively connected to a network 105, which is further communicatively connected to a central office 110. The network 105 may be implemented using any suitable communication interface including, for example, a telephone system, a cable system, a satellite system, a cellular communication system, AC power lines, the Internet, etc. The central office 110 is remotely located from the STBs 103 via the network 105 and collects viewership information, such as media exposure data, consumption data, media monitoring data, location information, and/or any other monitoring data that is collected by various media monitoring devices, such as the example STBs 103 and/or audience measurement devices.

In the illustrated example of FIG. 1, the central office 110 records the viewership information at a selected data rate (e.g., one data sample per second, one data sample per fifteen-minute period, etc.), and associates each measured data sample with a timestamp. The example central office 110 of the monitoring sub-system 102 may also validate the statistical significance of the collected household data and assign corresponding weights to the data. Such data weighting operations may allow the media researcher to employ particular demographic data sets having dissimilar sample numbers. For example, if 10,000 households represent viewership data for a first demographic group, and only 5,000 households represent viewership data for a second demographic group, then the example central office 110 may weight the second demographic group by a factor to indicate a relative confidence of the data. Viewership data is subsequently stored in a viewership database 115 for later use by an audience estimator 120.

The example audience estimator 120 includes an extensible markup language (XML) generator 130, an estimation engine 145, and an accumulator engine 175 to facilitate the methods and apparatus to calculate audience estimations disclosed herein. As described in further detail below, the XML generator 130 creates one or more XML files to, in part, facilitate a graphical user interface (GUI) for the user to select one or more characteristics of interest that may be used in a query of the viewership data. Additionally, the estimation engine 145 builds one or more characteristics arrays based on the user characteristic selection(s) of interest, each of which is used by the accumulator engine 175 to provide the user with an output report that indicates a count of the number of detected characteristics of interest.

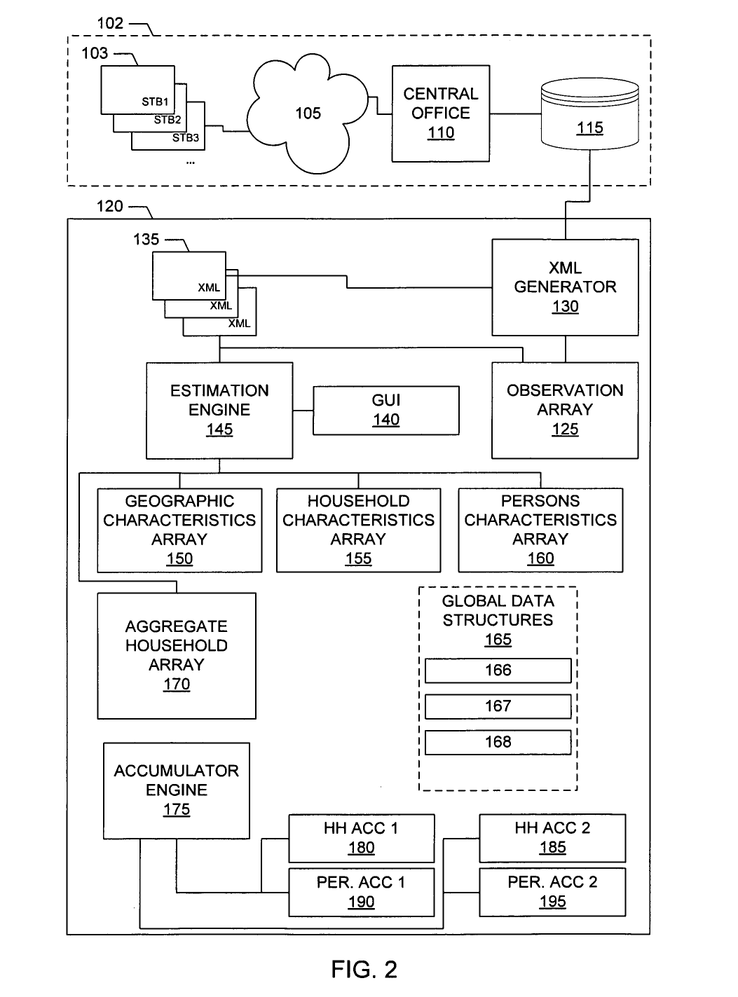

FIG. 2 illustrates the example audience estimator 120 of FIG. 1 in greater detail. The example XML generator 130 is communicatively connected to an observation array 125 and to the viewership database 115 of the example monitoring sub-system 102. As discussed in further detail below, the XML generator 130, before generating one or more XML files 135, creates the observation array 125 on a daily basis. While the viewership database 115 may include one or more days, weeks, months, and/or years of viewership data, the daily observation array 125 created by the XML generator 130 contains only viewership data corresponding to a single day, thereby minimizing any computational burden for subsequent query methods and apparatus. Based, in part, on the one or more characteristics contained within the daily viewership data extracted from the viewership database 115, the XML generator 130 generates the one or more XML files 135 that correspond to one or more detected characteristics. For example, the generated XML files 135 may include, but are not limited to, a person characteristics XML file, a household characteristics XML file, a viewed station XML file, a designated market area (DMA) XML file, and/or a geography XML file.

In the illustrated example of FIG. 2, the XML files 135 are used by an estimation engine 145 to generate a GUI 140 for use by the user. To streamline the efficiency and/or speed of viewership data analysis, the GUI 140 presented to the user is constrained to allow only query permutations for data characteristics that have been measured/occurred on the selected day. By eliminating user choices for characteristics that are not present within the observation array 125, the audience estimator 120 avoids wasted time and computational resources looking for query parameters that do not exist within the available data pool (e.g., characteristics not present within the observation array 125).

After the user initiates a query of the observation array 125 based on the available characteristics, the estimation engine 145 generates one or more focused sub-arrays to enable organizational tasks to be divided into efficient parts. The example sub-arrays may include, but are not limited to a geographic characteristics array 150, a household characteristics array 155, and a persons characteristics array 160. Each of the characteristics arrays 150, 155, and 160 are two-dimensional arrays, with the first dimension 1441 elements in length (i.e., elements 0 through 1440). More specifically, the first dimension of the array represents a corresponding minute of the day for a twenty-four hour period, and each corresponding index of the array may be calculated by way of example Equation 1 below.

Index=[(x*60)+y]−1 Equation 1.

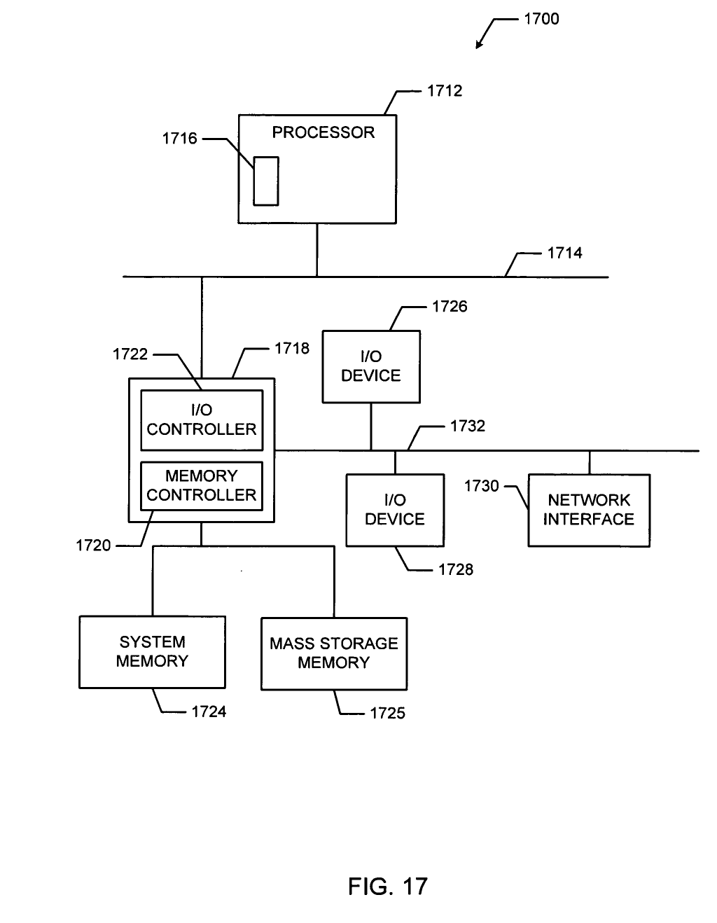

In the example Equation 1, x represents an hour of the day (e.g., from 0 to 23), and y represents a minute value (e.g., from 0 to 59). To illustrate, the index value that corresponds to twelve-noon is 719. Accordingly, because each of the multidimensional characteristics arrays have the same first dimension length, corresponding characteristic occurrences for a specific time of day may be accessed in a computationally efficient manner without cumbersome text searching techniques. For a time range selected by the user, such as from noon to 12:08 P.M. (i.e., index value 719 through 727), the example estimation engine 145 builds each of the characteristics arrays (e.g., 150, 155, 160) by iterating through the observation array 125 and extracting instances of matching characteristics identified by the user via the GUI 140. By creating a small number of characteristics arrays, each having the same first dimension length and a specific search objective when iterating through the observation array 125, processing demands are reduced and the arrays may be, in some instances, created as parallel threads in one or more computer systems, such as the example computer 1700 of FIG. 17.

As discussed in further detail below, the example XML generator 130 and/or the example estimation engine 145 may also reconcile details from a numeric value to a text value. Briefly, the example viewership database 115 and/or the observation array 125 may represent viewership data in a numeric manner (e.g., 0, 1, 2, 3, etc.) to minimize database storage use, to minimize communication bandwidth requirements, and to improve lookup speed. In some examples, a DMA identifier having the value of “2” may correspond to the Chicago metropolitan area. Continuing with this example, a geographic identifier having the value of “0” may correspond to Cook County, which may be one of several counties within the Chicago metropolitan area. However, in a separate DMA, such as the Milwaukee metropolitan area having a corresponding DMA identifier of “1,” an associated geographic identifier of “0” may refer, instead, to Waukesha County. To reconcile such numerical representations of characteristics to human-readable information, the illustrated example audience estimator 120 includes one or more global data structures 165. The example global data structures 165 of FIG. 2 include, but are not limited to a household reference characteristics sub-structure 166, a person reference characteristics sub-structure 167, and a geography reference sub-structure 168 to facilitate numeric look-up and reconciliation. While the use of such numeric identifiers in a large database, such as the example viewership database 115, saves considerable memory and improves database management, the observation array 125 and/or the corresponding characteristics arrays 150, 155, 160 are significantly smaller in size and respond faster because, in part, they contain viewership information corresponding to only a single 24-hour period. Accordingly, the faster characteristics arrays 150, 155, 160 may afford reconciliation of the numeric representation(s) back to a text representation with less computational delay as compared with larger and/or traditional databases.

Upon completion of building the geographic characteristics array 150, the household characteristics array 155, and the persons characteristics array 160, the example estimation engine 145 uses these arrays when building the aggregate household array 170. The example aggregate household array 170, much like the characteristics arrays 150, 155, and 160, includes a primary (e.g., a first dimension) index that is 1441 elements (index values 0 through 1440) in length, with each index value indicative of a one minute period during a twenty-four hour day. In the illustrated example of FIG. 2, the estimation engine 145 populates the aggregate household array 170 with corresponding characteristics detected from the geographic characteristics array 150, the household characteristics array 155, and the persons characteristics array 160 so that each row includes a corresponding column indicative of whether or not a selected criteria was detected during the corresponding minute of the day. While each row of the aggregate household array 170 represents a single minute from the day, a second array dimension is allocated to represent multiple occurrences of the characteristics so that the primary array dimension is maintained at a constant size. For example, assuming for purposes of illustration, only three households existed (e.g., three separate set-top boxes) with corresponding characteristic matches at 12:01 P.M., then the primary array dimension index corresponding to that time of day would be 720, and the secondary array dimension at that time of day would be three elements in length (e.g., elements 0, 1, and 2) to represent each of the three set-top boxes.

To provide the user with a report of matching characteristics of interest, the illustrated example audience estimator 120 of FIG. 2 includes an accumulator engine 175 to generate corresponding accumulators. For example, if the user selects, via the XML-based GUI 140, a first and second household characteristic, and a first and second person characteristic, then the example accumulator engine 175 generates a first household characteristic accumulator 180, a second household characteristic accumulator 185, a first person characteristic accumulator 190, and a second person characteristic accumulator 195. To illustrate further, an example first household characteristic may be households having basic cable television service, an example second household characteristic may be households having a high-definition broadcast signal (e.g., a premium cable subscription), an example first person characteristic may be males ages 18-24, and an example second person characteristic may be females ages 18-24. Accordingly, the accumulators generated based on these example user selected characteristics of interest are incremented as the example accumulator engine 175 iterates through the aggregate household array 170. In the event that the accumulator engine 175 identifies a household containing one or more of the desired characteristics of interest, the corresponding accumulator is incremented.

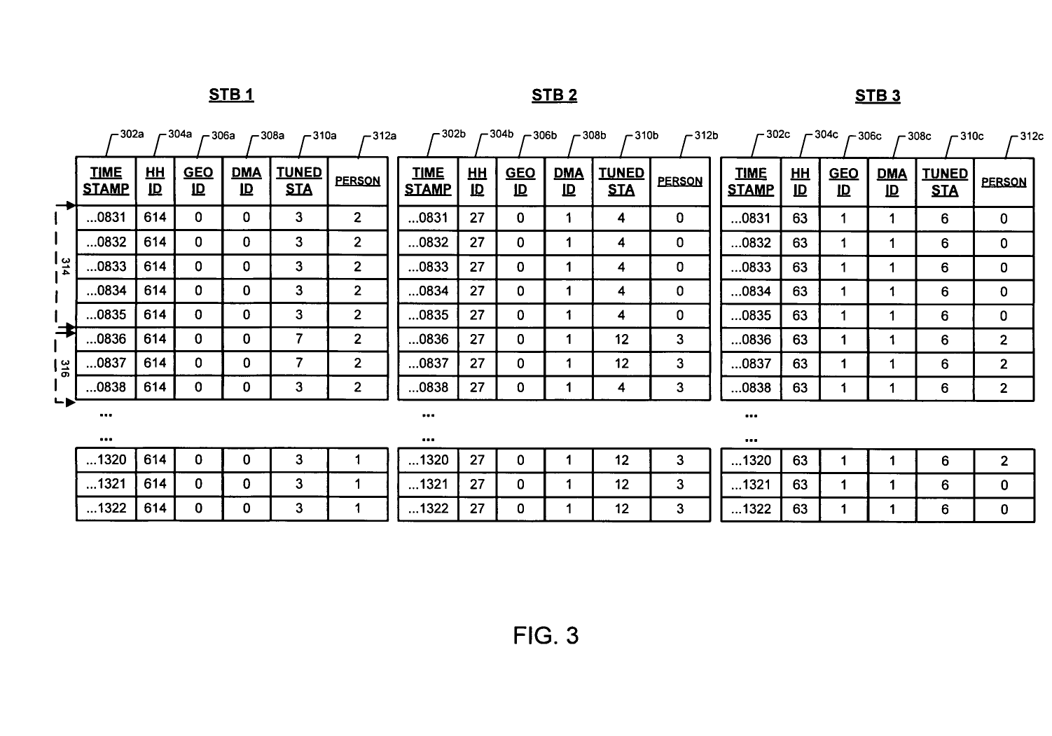

Turning now to FIGS. 3-11, methods and apparatus associated with the example audience estimator 120 of FIG. 2 will be described in further detail. FIG. 3 illustrates an example arrangement of viewership information 300 stored in the viewership database 115. The example arrangement of viewership information 300 illustrates a relatively small subset of household viewership data corresponding to example first, second, and third STBs (i.e., STB1, STB2, and STB3). For purposes of illustration, and not limitation, only three example STBs are shown in the illustrated example of FIG. 3, in which each STB corresponds to one household having one or more household members therein. Each STB may be associated with a single DMA, in which each DMA may be further broken down by county and/or city. In some examples, a first DMA may be associated with a relatively large metropolitan area, such as Los Angeles, while a second DMA may be associated with any number of smaller metropolitan rural area(s).

In the illustrated example of FIG. 3, each STB (i.e., STB1, STB2, and STB3) includes a timestamp field 302a-c, a household identifier (HH ID) 304a-c, a geography identifier (GEO ID) 306a-c, a DMA identifier (DMA ID) 308a-c, a tuned station 310a-c, and a person identifier 312a-c. The timestamp fields 302a-c in the illustrated example of FIG. 3 show a resolution of one minute, but may include, without limitation, a corresponding day, month, year, day of the week, and/or second. Additionally, while the example timestamp fields 302a-c illustrate a resolution of 1-minute, any other resolution may be employed, without limitation. In particular, media researchers may prefer a resolution with less granularity (e.g., a viewership data sample once every 5-minutes) because only data that includes stable household member viewing (e.g., viewing without channel-surfing) is of interest to the media researcher.

The example HH ID 304a-c includes a numerical identifier of an STB, which is a unique value unduplicated by any other STB. Additionally or alternatively, the HH ID 304a-c may be a unique value only to the DMA with which it is associated. For example the HH ID value “614” may correspond to one STB in a first DMA, while the HH ID value of “614” may correspond to a separate STB in a dissimilar second DMA. Furthermore, each STB (e.g., STB1, STB2, STB3) includes a DMA ID field 308a-c to identify the DMA with which the STB is associated. Accordingly, each STB may be referenced in a hierarchical manner by determining its associated DMA ID, its associated GEO ID, and corresponding unique HH ID. As described in further detail below, knowledge of the corresponding DMA ID, GEO ID, and/or HH ID enables reconciliation of and/or reference to corresponding characteristics related to the DMA ID, GEO ID, and/or HH ID. For example, an example HH ID value of “614” shown in FIG. 3 consumes a relatively small amount of memory of the viewership database 115 versus additional household information related to economic characteristics, race characteristics, and/or a number of people within the household associated with the HH ID value of “614.” Accordingly, the HH ID value(s) facilitate an opportunity to reference the global data structures 165 of FIG. 2 to reconcile additional details related to the HH ID value(s) 304a-c.

The GEO ID fields 306a-c identify a corresponding geographic identifier associated with the viewership data acquired at the corresponding timestamp 302a-c. STB1, the example of FIG. 3, includes a GEO ID value of “0.” For example, the GEO ID value of “0” may refer to a specific county or city within a particular DMA. To illustrate, the GEO ID value of “0” may refer to Cook county for the corresponding DMA value “0,” the latter of which may be indicative of the greater Chicago metropolitan area. However, a GEO ID value of “1” within that same DMA for the greater Chicago metropolitan area may correspond to DuPage county, which is physically adjacent to Cook county.

Each STB also includes the TUNED STA field 310a-c to identify, at each associated timestamp, the station to which the corresponding STB was tuned. Additionally, the PERSON field 312a-c indicates which person within the household was watching the audio/visual equipment associated with the STB. In some examples, each monitored household may have a PeopleMeter® to determine which household member is using the STB.

As described above, the illustrated example of FIG. 3 only presents three example STBs (i.e., STB1, STB2, and STB3), but at least one practical concern includes the vast number of individual STBs for which the example viewership database 115 stores data. Each viewership database 115 may track and store data for any number of DMAs throughout a geographic area (e.g., a state, several states, a region, a country, etc.), in which each DMA includes any number of individual geographic identifiers (e.g., counties, cities, zip codes, etc.). To that end, the example viewership database 115 may store data associated with several thousand individual STBs. As the measurement resolution increases (e.g., viewership data samples taken once every 5 minutes to data samples taken once every minute), so too do the storage requirements of the viewership database 115. Consequently, one or more media researchers may encounter significant delay when making a query of the viewership database 115 in an effort to better understand and/or determine viewership trends based on one or more search terms.

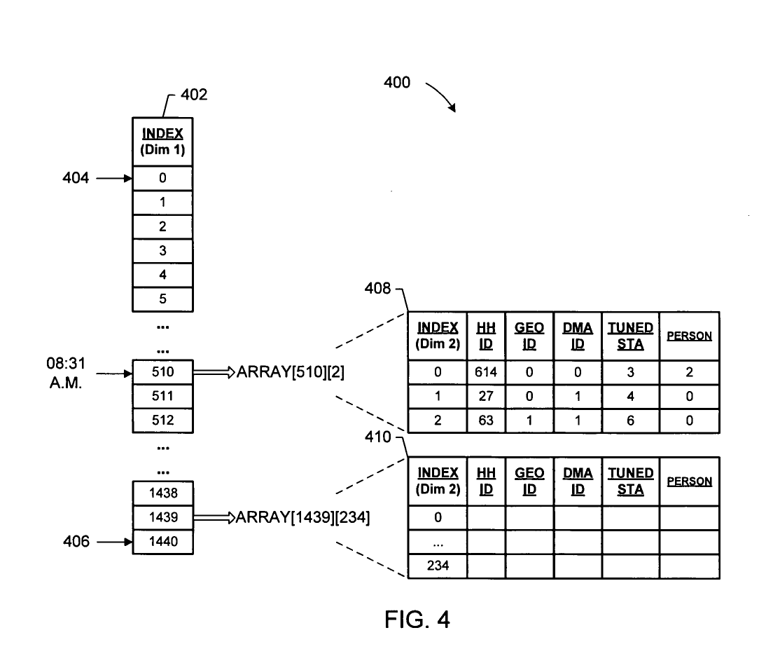

To improve the speed at which a query may be made of viewership data, the example audience estimator 120 employs the XML generator 130 to perform a daily build of the observation array 125. In the illustrated example of FIG. 4, an example arrangement of daily viewership information 400 stored in the observation array 125 is shown. In some examples, the XML generator 130 builds the observation array 125 during hours of the day when computing resource demands are expected to be low, such as during the early morning hours between 2:00 A.M. and 5:00 A.M. In operation, the example XML generator 130 parses the viewership database 115 for timestamps (e.g., the timestamp fields 302a-c) that corresponds to the previous day of viewership data collection. To that end, any subsequent analysis of viewership data by the audience estimator 120 occurs on a dataset (i.e., the observation array 125) that is substantially smaller than the viewership database 115, thereby facilitating a relatively faster response time. For archival purposes, each daily observation array 125 may be stored for later retrieval and analysis to, for example, compare viewership trends based on the day of week, study viewership trends based on particular sporting events, and/or study viewership trends based on seasonal factors (e.g., comparing viewership habits during a Thursday night in the winter season versus viewership habits during a Thursday night in the summer season).

The example observation array 125 viewership arrangement 400 includes a two-dimensional array having a first (primary) dimension 402 that is 1441 elements in length. A first index 404 (i.e., index value “0”) of the first dimension 402 corresponds to 12:01 A.M., and the last index 406 (i.e., index value “1440”) of the first dimension 402 corresponds to 12:00 A.M. As described above, Equation 1 enables the corresponding index value to be calculated based on the time-of-day. For example, at 8:31 A.M., Equation 1 yields an index value of “510.” Similarly, an index value of “511” corresponds to 8:32 A.M., an index value of “512” corresponds to 08:33 A.M., etc. At least one benefit of building the example observation array having index values that correspond to a single minute within a 24-hour period is that any query for viewership data for a particular time of day may be quickly performed via array mathematics, which is generally regarded as a fast and efficient technique for computers and/or computer systems. Additionally, in the event that a media researcher chooses to query multiple observation arrays (e.g., from one or more alternate days during the year), then comparisons may be made from one day to the next on separate arrays, each having the same index access locations that correspond to the same time-of-day, thereby improving query efficiency.

To build the daily observation array 125, the example XML generator 130 identifies only viewership data entries from the viewership database 115 that correspond to the selected day (e.g., the previous day) and extracts such viewership data therefrom. The example arrangement 400 of the observation array 125 also includes a second dimension in which the extracted viewership data is placed. In the illustrated example of FIG. 4, a second dimension 408 of the array is shown that is associated with the primary dimension 402 corresponding to 8:31 A.M. (i.e., primary index value “510”). The example second dimension 408 is also represented in each of the other primary index locations only if there exists associated viewership data during the corresponding time period.

For example, because some media researchers have no interest in viewership data associated with viewers that channel-surf, the XML generator 130 may filter extracted viewership data from the viewership database 115 so that only data containing at least 5-minutes of same-station viewing is retrieved. Such filtering is represented in the example second array dimension 408 of FIG. 4. Briefly returning to FIG. 3, a first group of viewership samples 314 illustrates five consecutive minutes of viewing (i.e., 0831 through 0835) in which the station remained constant for each of STB1, STB2, and STB3. As a result, the example XML generator 130 extracted the viewership data from the consecutive timeframe of the first group 314 and stored it in the observation array 125. More specifically, row elements “0,” “1,” and “2” of the second array dimension 408 of FIG. 4 include viewership information from STB1, STB2, and STB3 for the corresponding times because the five-minute same-station threshold was met. On the other hand, a second group of viewership samples 316 in example FIG. 3 illustrates one or more rows of viewership data in which the example five-minute consecutive viewing criteria is not satisfied. In particular, STB1 includes only two-minutes of viewing time with station “7,” and STB2 includes only two-minutes of viewing time with station “12.” Accordingly, because STB1 and STB2 did not satisfy the five-minute threshold, corresponding viewership data (i.e., at 8:36 A.M. and 8:37 A.M.) were not extracted from the viewership database 115 and saved to the observation array 125. While the example time threshold described above is five-minutes, any other time threshold, or no time threshold, may be used instead.

Returning to FIG. 4, the example second array dimension 408 associated with the primary index value 510 (i.e., 8:31 A.M.) is three elements in length (i.e., elements 0, 1, and 2) because only STB1, STB2, and STB3 exhibited viewership data at that time (and within the 5-minute threshold). While only three STBs are used in the immediate example, such STBs are for illustrative purposes and actual quantities of qualifying STBs may be numbered in the hundreds or thousands, without limitation. The example second array dimension 408 is as long as necessary to accommodate qualifying STBs having data in the viewership database 115. To illustrate, if at 11:59 P.M. (i.e., corresponding index value “1439”) there were 235 STBs in the viewership database 115 that have viewership data, and each tuned station was selected by the household for five consecutive minutes (or longer), then the second array dimension 410 would be 235 elements long (i.e., array index values from 0 to 234).

After building the observation array 125, the example XML generator 130 generates the XML files 135 based on the available characteristics in the observation array 125. As described above, the example XML generator 130 creates a person characteristics XML file, a household characteristics XML file, a viewed station XML file, and/or a geography XML file. In the illustrated example of FIG. 2, the XML files 135 represent available characteristics from which a user may select when performing one or more queries of the observation array 125. The XML files 135, in part, enable a GUI to be generated that constrains the user to select query options that are actually represented by the retrieved data. In other words, if the retrieved data in the observation array 125 does not include a particular characteristic, then the GUI generated based on the XML files 135 will not allow the user to select such un-represented characteristic(s).

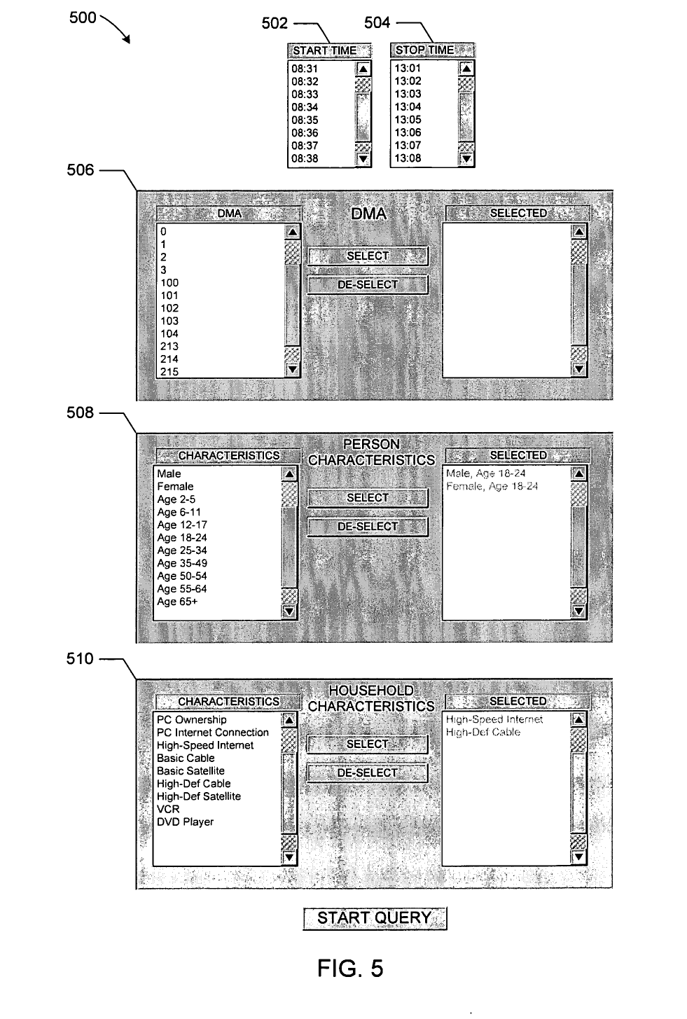

FIG. 5 illustrates an example GUI 500 prior to the generation of the XML files 135 by the XML file generator 130. In operation, the example estimation engine 145 builds the GUI 140 based on available characteristics contained within the observation array 125, as determined from the XML files 135. However, prior to the XML file creation by the XML generator 130, the GUI 500 of FIG. 5 presents the user with a start-time field 502, a stop-time field 504, a DMA field 506, a person characteristics field 508, and a household characteristics field 510. In the example of FIG. 5, the GUI 500 has all such characteristics grayed-out because the XML files 135 have not yet been generated to instruct the estimation engine 145 which characteristics to make available to the user.

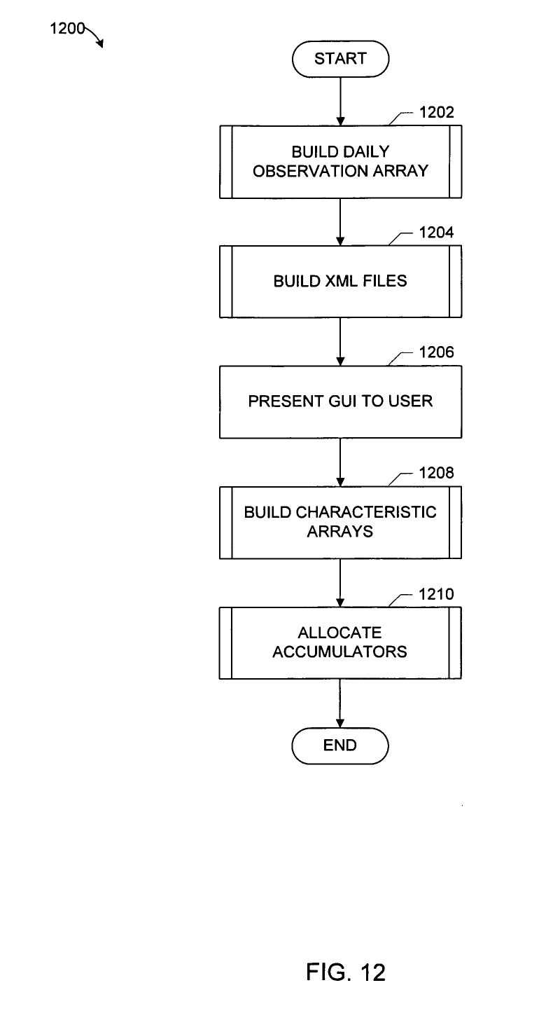

As described in further detail below in conjunction with the flowcharts of FIGS. 12-16, the XML generator 130 creates the XML files 135 in an iterative manner. In particular, because the observation array 125 includes a first dimension of a known length (e.g., 1441 index elements), the XML generator 130 initiates a loop that iterates once for each element in the first dimension. During each iteration of one primary dimension element (i.e., corresponding to a single minute of the day), the XML generator 130 determines if the second dimension contains any data. If no data has been collected for a particular time of day, then the second dimension may contain a null pointer to allow the loop to move on to the next element in the first dimension. On the other hand, if the second dimension of the array includes viewership data, the XML generator 130 parses the second dimension for an instance of person characteristics. For example, briefly returning to FIG. 4, if the XML generator 130 parses the secondary array 408 for person characteristics, elements 0, 1, and 2 of the secondary array include person values of “2,” “0,” and “0” that correspond to household identifier values of “614,” “27,” and “63,” respectively. While such numerical representations of households and persons within the household may be efficient for numerical manipulation in an array, such numerical representations are not human-readable. Accordingly, the example XML generator 130 references the global data structures 165 to reconcile the particular persons characteristics associated with the identified person values of “2,” “0,” and “0” for the respective households.

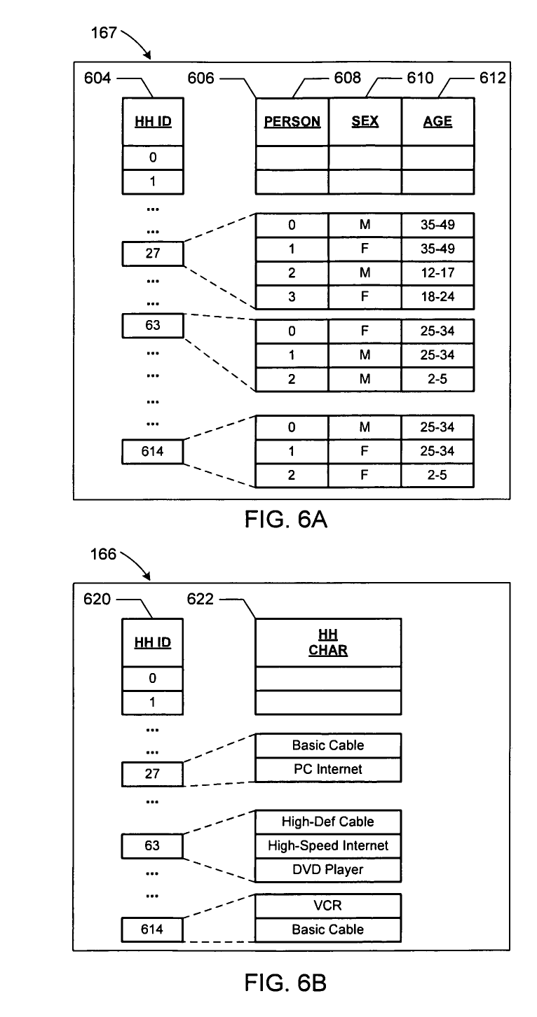

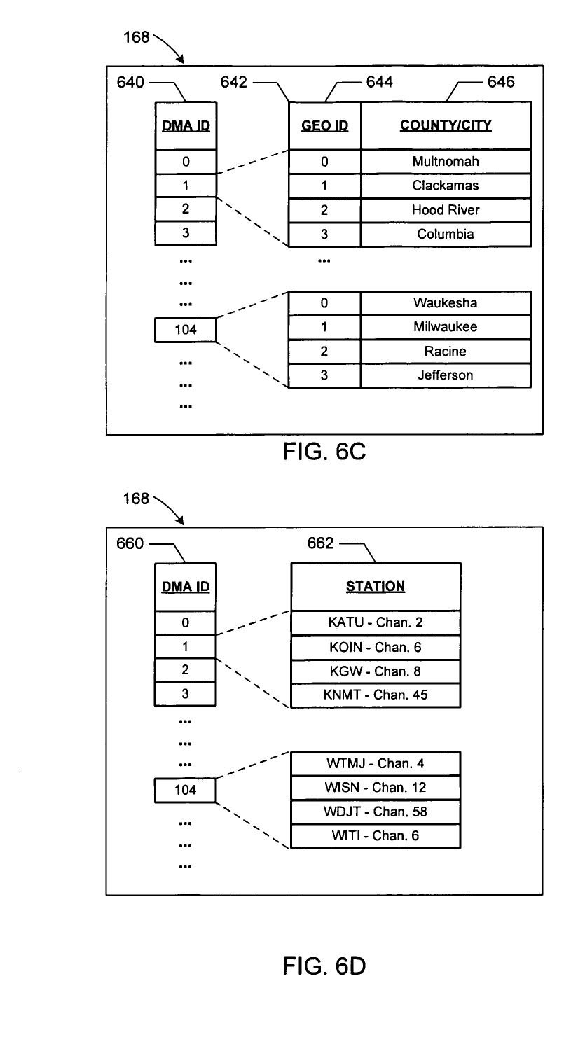

Reconciliation via the global data structures 165 is shown in further detail in FIG. 6A. In the example illustration of FIG. 6A, a person characteristics reference array 167 is shown with a household identifier index column 604 and each index of that column points to a second dimension of the array 606 that is n elements in length. The value of n depends upon how many members constitute the corresponding household, such as a family of four with four rows within the secondary dimension (e.g., index values 0, 1, 2, 3), or a family of three having three rows within the secondary dimension (e.g., index values 0, 1, and 2). The secondary dimension 606 includes a person field 608, a sex field 610, and an age field 612. To illustrate reconciliation of the numerical fields within the observation array 125 into human readable information for the XML files 135, briefly refer to array element “510” of the observation array 125 of FIG. 4. In the illustrated example of FIG. 4, array element “510,” which is a first dimension index value, refers to a second dimension of size three, thereby illustrating that three STBs contain relevant viewership data (e.g., second dimension elements 0, 1, and 2). The example XML generator 130 parses array element “510” by starting with the first element of the second dimension, which in the illustrated example of FIG. 4, is element “0.” Element “0” corresponds to household “614” and person “2,” which is used by the XML generator 130 when referencing the global data structures 165. Starting with the household identifier of “614,” the XML generator 130 references the persons characteristic reference array 167 to determine that the person that corresponds to value “2” in household “614” is a female between the ages of 2 and 5, as shown in FIG. 6. To that end, the XML generator 130 generates the XML files 135 to include the persons characteristics of “Female, Age 2-5.” As the example XML generator 130 continues to iterate through the second dimension 408, any additional persons characteristics are detected, reconciled, and added to the XML files 135 in a similar manner.

Continuing with the aforementioned example, when the example XML generator 130 reaches the last element (i.e., element “2”) in the second dimension 408 of the array element 510 (i.e., 8:31 A.M.), the search for persons characteristics for that time-of day stops and a search for household characteristics begins. The XML generator 130 returns to the first element in the second dimension 408 (i.e., element “0”) and parses for household characteristics. In a manner similar to the reconciliation via the persons characteristic reference array 167 above, the example household characteristics reference array 166 is shown in FIG. 6B to reconcile numeric household references with human-readable information. The household characteristics reference array 166 includes a household identifier index column 620 and each index of that column points to a second dimension of the array 622 that is n elements in length. The value of n depends upon the number of household characteristics that are associated with the corresponding household identifier, such as whether or not the household has cable television, internet access, high-speed internet access, high-definition television services, etc. To reconcile corresponding household characteristics in the observation array into the XML files 135, the example XML generator 130 references the household characteristics reference array 166 of the global data structures 165 to determine which characteristics should be added to the XML files 135. In the example of FIG. 4, as the XML generator 130 iterates through the first dimension element “510,” the HH ID field value of “614” is referenced against the household characteristics reference array 166 to determine that the XML files 135 should include “VCR” and “Basic Cable” as the household characteristics associated with that household.

The DMA ID and GEO ID values from the example observation array also allow further human-readable resolution of which DMA and corresponding geography with which the household is associated. FIG. 6C illustrates an example geography reference array 168 that includes a first dimension index 640 having a unique DMA ID therein. Additionally, the example geography reference array 168 includes a second dimension array 642 having a length of n, which is dependent upon how many counties or cities define the corresponding DMA. In some examples, the DMA ID may refer to a relatively large geographic area having many counties therein, while other DMA ID values may refer to relatively smaller geographic areas and/or areas have fewer households and/or counties. In operation, the XML generator 130 references a DMA ID of the observation array to determine which corresponding counties or cities may be candidates for user selection during any subsequent viewership query. Additionally, the XML generator 130 determines a county or city name by further referencing a specific GEO ID value. To illustrate, household “27” from FIG. 4 indicates a DMA ID value of “1” and a GEO ID value of “0.” The XML generator 130 accesses the geography reference array 168 of FIG. 6B using the DMA ID value of “1,” and then accesses the corresponding GEO ID value of “0” to yield a county name of “Multnomah.” With the county name reconciled, the XML generator 130 adds the county name to the XML files 135 to facilitate later selection by the user when performing a query on the observation array 125 data. Also shown in the example geography reference array 168 of FIG. 6C are additional DMA ID values, each of which may include any number of corresponding cities, counties, and/or any other geographic identifier of interest. Furthermore, as market researchers increase the number of DMAs, delete DMAs, and/or edit DMAs, the example geography reference array 168 may be updated to reflect any changes, as needed.

The example geography reference array 168 also includes a corresponding station array 662 to reconcile which stations are available candidates for each corresponding DMA, as shown in FIG. 6D. Generally speaking, each DMA is large enough to capture most major network broadcasting areas, but may not be too large to permit channel overlap. In other words, a single DMA may be large enough to include two separate NBC affiliates, one broadcasting on channel 4 and another affiliate broadcasting on channel 5, but the DMA does not typically expand to additional geographies that may also use either of channels 4 or 5 for any other network(s). In the illustrated example of FIG. 6D, the DMA ID column 660 may be referenced by the XML generator 130 to access one or more specific channels that typically broadcast in that geographic region. Such one or more specific channels are listed in the corresponding station array 662 and may be added to the XML files 135.

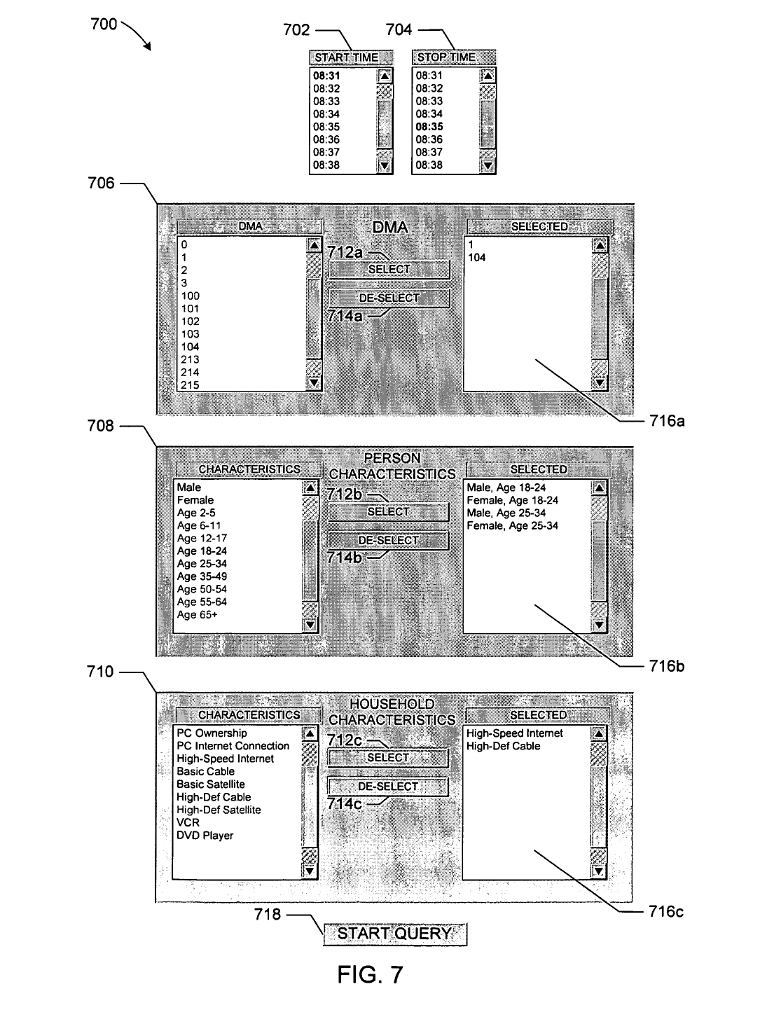

Upon completion of building the XML files 135, the estimation engine 145 reformats the GUI 700 as shown in FIG. 7. Note that the example GUI 500 of FIG. 5 is similar to the GUI 700 of FIG. 7, both of which include similar reference numbers to refer to similar items. However, only those characteristics that were actually detected in the observation array 125 are made available (e.g., selectable) to the user. Characteristics that were not determined by the XML generator 130 to be present in the observation array 125, and thus not written to the XML files 135, are shown grayed-out and not selectable by the user. In operation, a user selects a value in the start-time field 702, a value in the stop-time field 704, one or more available DMAs from the DMA field 706, one or more available person characteristics of interest from the person characteristics field 708, and one or more available household characteristics from the household characteristics field 710. While the example DMA field 706 of FIG. 7 illustrates selection of desired DMAs of interest, the DMA field 706 is not limited thereto. For example, the DMA field 706, or a separate selection field, may present one or more counties and/or cities to the user for selection. Selection and/or de-selection of the one or more DMAs and/or characteristics are realized by way of selection button(s) 712a-c, and a de-selection button(s) 714a-c. After the user has placed desired characteristics of interest in corresponding selection fields 716a-c, the user may select the start query button 718 to initiate an analysis of the data within the example daily observation array 125.

In response to the user request to initiate the query, the example estimation engine 145 builds corresponding characteristics arrays based on the user selections from the GUI. As described above, query speed advantages are realized, in part, by subdividing the viewership data analysis into smaller, more specialized and computationally manageable operations. To that end, the example estimation engine 145 builds each two-dimensional characteristics array having the same first-dimension length of 1441 so that the smaller number of characteristics arrays (150, 155, 160) can perform a specialized, efficient compilation of characteristics.

The example estimation engine 145 allocates the two-dimensional geography characteristics array 150 with a first dimension that is 1441 elements in length (i.e., index values 0 through 1440), in which each indicie of the second dimension is initialized with a null character to indicate no available data. Based on the user timeframe selection in example FIG. 7 of a start-time at 8:31 A.M. and a stop-time at 8:35 A.M., the estimation engine 145 calculates corresponding index values to be used in a computational loop. More specifically, the estimation engine 145 employs Equation 1 above to calculate a start-time index of “510” and a stop-time index of “514.” As such, further computation and/or manipulation of the geography characteristics array 150, the observation array 125, and/or any other array is reduced to address only the selected timeframe of interest, thereby increasing computational efficiency and reducing query response time. Starting with the start-time index of “510,” the estimation engine 145 accesses the observation array 125 at the current index location and parses the second dimension thereof to extract viewership information indicative of DMAs of interest, counties of interest, and/or cities of interest selected by the user in the example GUI 700. As described above, the GUI 700 of FIG. 7 illustrates one or more example selections (in bold text) for purposes of demonstration and not limitation.

Continuing with the example GUI 700 of FIG. 7, the estimation engine 145 parses the second dimension of the observation array 125 to retrieve any data associated with DMAs 27, 63, and 614. After all second dimension array elements are parsed with respect to the first dimension index value (i.e., index location “510”), the estimation engine 145 increments to the next first dimension index value (i.e., index location “511”) to parse the second dimension array elements for additional viewership information indicative of the geography characteristics of interest.

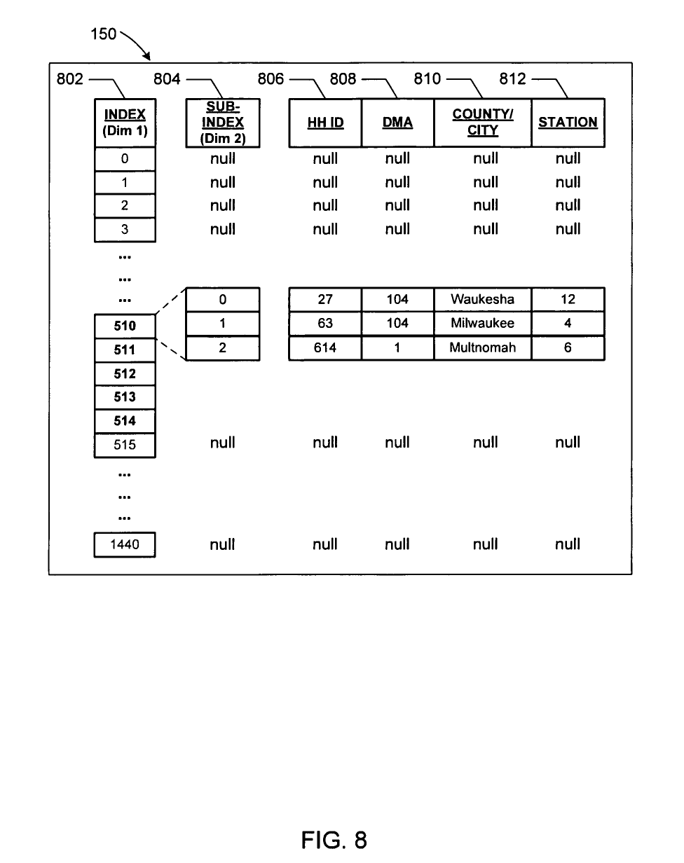

FIG. 8 illustrates an example geography characteristics array 150 that is generated by the estimation engine 145 in response to the user inputs of the example GUI 700. In the illustrated example of FIG. 8, the geography characteristics array 150 includes a first dimension 802 with index values ranging from 0 through 1440 to represent each minute of a 24-hour day. Each first dimension index value points to a second dimension 804 that is n elements in length, in which the value of n is based on how many characteristics were extracted from the observation array 125 based on the user selection(s). For example, first dimension element “510” of the illustrated example of FIG. 8 includes a second dimension three elements in length (i.e., elements 0, 1, and 2) based on the estimation engine 145 detecting three matching characteristics of interest for the time period of 8:31 A.M. Other time periods may include more or fewer elements within the second dimension 804 based on one or more matching characteristics. The second dimension 804 also includes a household identifier field (HH ID) 806 to identify a unique household within the viewing audience, a DMA field 808 to identify the associated DMA within which the household is located, a county/city field 810 to identify a specific county or city within the DMA, and a station field 812 to identify to which station the household was tuned-to at the time associated with the first dimension 802. Each row within the second dimension 804 for the corresponding first dimension index corresponds to a single household within the viewing audience, and the associated fields of each index of the second dimension 804 provide characteristic details of each household. First dimension 802 index values that are not part of the start-time and stop-time are not part of the analysis loop and have each corresponding second dimension 804 initialized with a null character and/or any other indicia to indicate no further need to analyze.

Upon completion of the geography characteristics array 150, the example estimation engine 145 begins construction of the household characteristics array 155 in a similar manner. In one example construction of the household characteristics array 155, the estimation engine 145 parses the second dimension of the observation array 125 using the same first dimension index values calculated earlier (e.g., based on the start-time and the stop-time of interest). During parsing of the observation array 125, the estimation engine 145 retrieves any data associated with previously identified household characteristics of interest, such as households having high-speed internet access and households having high-definition cable service(s), as shown in the illustrated example of FIG. 7.

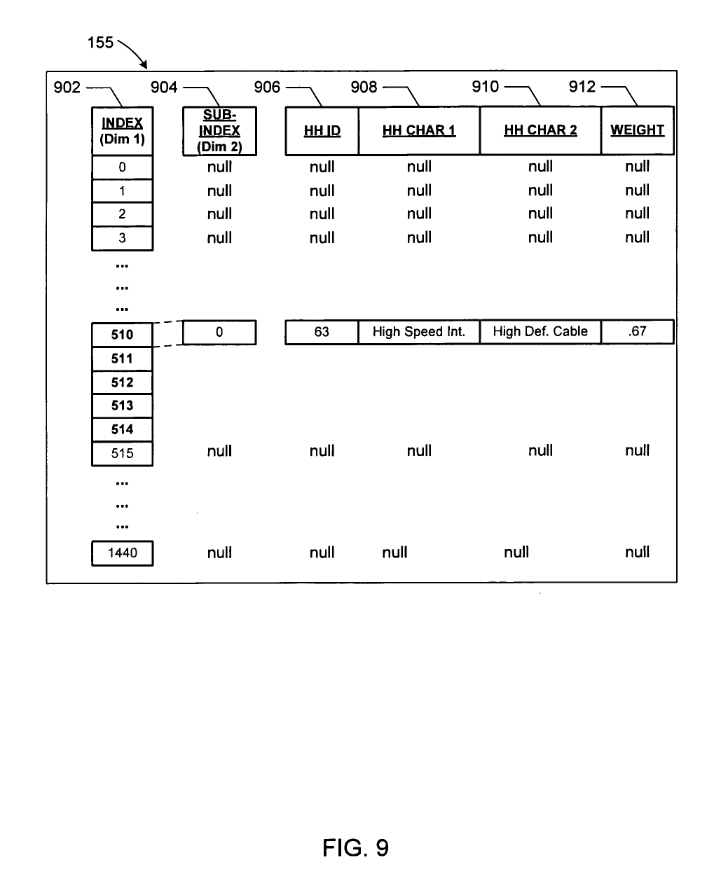

FIG. 9 illustrates an example household characteristics array 155 that is generated by the estimation engine 145 in response to such user inputs of the example GUI 700. In the illustrated example of FIG. 9, the household characteristics array 155 includes a first dimension 902 that, much like the example geography characteristics array 150 of FIG. 8, includes index values from 0 through 1440 to represent each minute of a 24-hour day. Each first dimension index value points to a second dimension 904 that is n elements in length, in which the value of n is based on how many characteristics were extracted from the observation array 125 based on the user selection(s). The second dimension 904 also includes a household identifier field (HH ID) 906 to identify a unique household within the viewing audience, a first household characteristics field 908, a second household characteristics field 910, and a weight field 912 to apply one or more weighting factors to the viewership data associated with the HH ID.

While two example household characteristics fields 908 and 910 are illustrated in FIG. 9, any number of household characteristics fields may be present. Additionally or alternatively, a single household characteristics field may be provided in the second dimension 904 in which multiple characteristics are written as comma separated values therein. In view of the example GUI 700, the user requested corresponding households that include high-speed internet services and high-definition cable television services. Only HH ID “63” includes such matching characteristics so the corresponding second dimension 904 is only a single element in length (e.g., index value 0). Additionally, to derive the text of “High Speed Internet” and “High Definition Cable” to be placed in the example household characteristics array 155, the estimation engine 145 reconciles the available household characteristics for any particular household with the household characteristics reference array 166 in the global data structures 165, in a manner similar or identical to that discussed above in view of FIG. 6A.

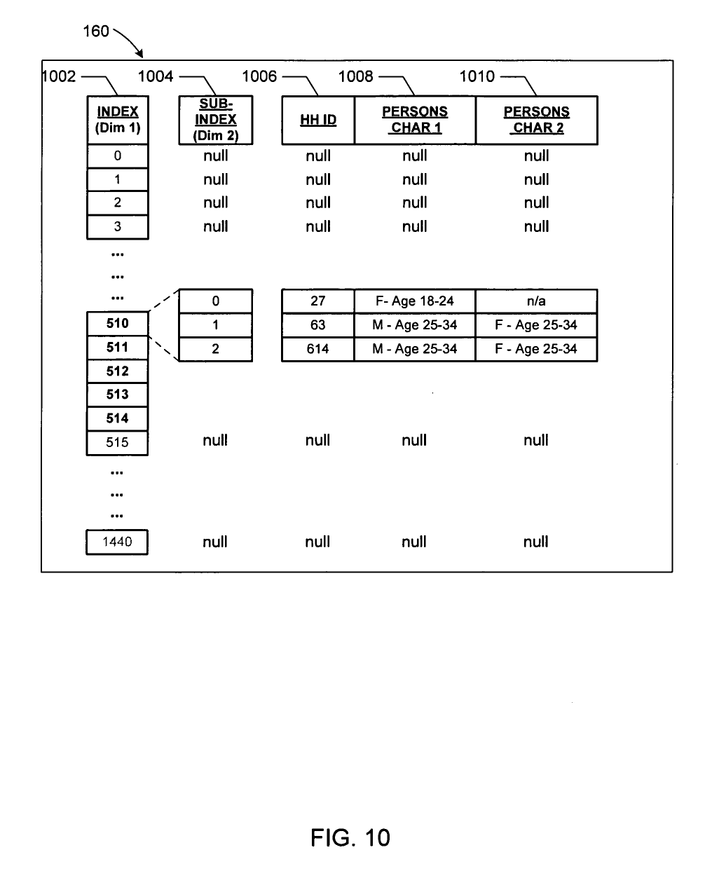

Upon completion of the household characteristics array 155, the example estimation engine 145 begins construction of the persons characteristics array 160 in a similar manner as discussed in view of the geography characteristics array 150 and the household characteristics array 155. In one example construction of the persons characteristics array 160, the estimation engine 145 parses the second dimension of the observation array 125 using the same first dimension index values calculated earlier (e.g., based on the start-time and the stop-time of interest). During parsing of the observation array 125, the estimation engine 145 retrieves any data associated with previously identified persons characteristics of interest, such as males and females between the age categories of 18-24 and 25-34, as shown selected by the user in the example GUI 700 of FIG. 7. FIG. 10 illustrates an example persons characteristics array 160 that is generated by the estimation engine 145 in response to such user inputs of the example GUI 700. In the illustrated example of FIG. 10, the persons characteristics array 160 includes a first dimension 1002 that, much like the example characteristics arrays described above, includes index values ranging from 0 through 1440 to represent each minute of a 24-hour day. Each first dimension index value points to a second dimension 1004 that is n elements in length, in which the value of n is based on how many characteristics were extracted from the observation array 125 based on the user selection(s). The second dimension 1004 also includes a household identifier field (HH ID) 1006 to identify a unique household within the viewing audience, a first persons characteristics field 1008, and a second persons characteristic field 1010. While two example persons characteristics fields 1008 and 1010 are illustrated in example FIG. 10, any number of persons characteristics fields may be present. Additionally or alternatively, a single persons characteristics field may be provided in the second dimension 1004 in which multiple persons characteristics are written as comma separated values therein.

In the illustrated example of FIG. 10, the second array dimension 1004 associated with index “510” includes three elements because the example estimation engine 145 detected three households that contain characteristics matching those selected via the example GUI 700 of FIG. 7. More specifically, while the example GUI 700 selected Males and Females between the ages of 18-24 and 25-34, the household associated with HH ID “27” only included one member of that group of interest (i.e., Females, age 18-24). Accordingly, the persons characteristics array 160 now includes an entry of “F-Age 18-24” in the first persons characteristic field 1008 to acknowledge the match, while the second persons characteristic field 1010 includes an entry of “n/a” to communicate that the household does not contain any further matches. On the other hand, both households associated with HH IDs “63” and “614” have two matching persons characteristics, which are located in the first and second persons characteristics fields 1008 and 1010.

Each of the geographic characteristics array 150, the household characteristics array 155, and the persons characteristics array 160 are used to generate a two-dimensional aggregate household array 170 that will consolidate the characteristics of interest identified by the example GUI 700. Although the example aggregate household array 170 is allocated with a first dimension of 1441 elements for ease of precise time-based referencing, as described above, only those index values that correspond to the selected start-time and stop-time are populated with the characteristic results from the geographic characteristics array 150, the household characteristics array 155, and the persons characteristics array 160. At least one benefit realized from generating the aforementioned characteristics arrays (150, 155, 160) prior to generating the aggregate array 170 is that the audience estimator 120 is able to subdivide extraction tasks in a focused and precise manner rather than attempt to invoke a direct query against a large database with a large number of characteristics of interest. Additionally, one or more of the tasks associated with generating the characteristics arrays (150, 155, 160) may operate on one or more processors and/or processing threads in a parallel manner.

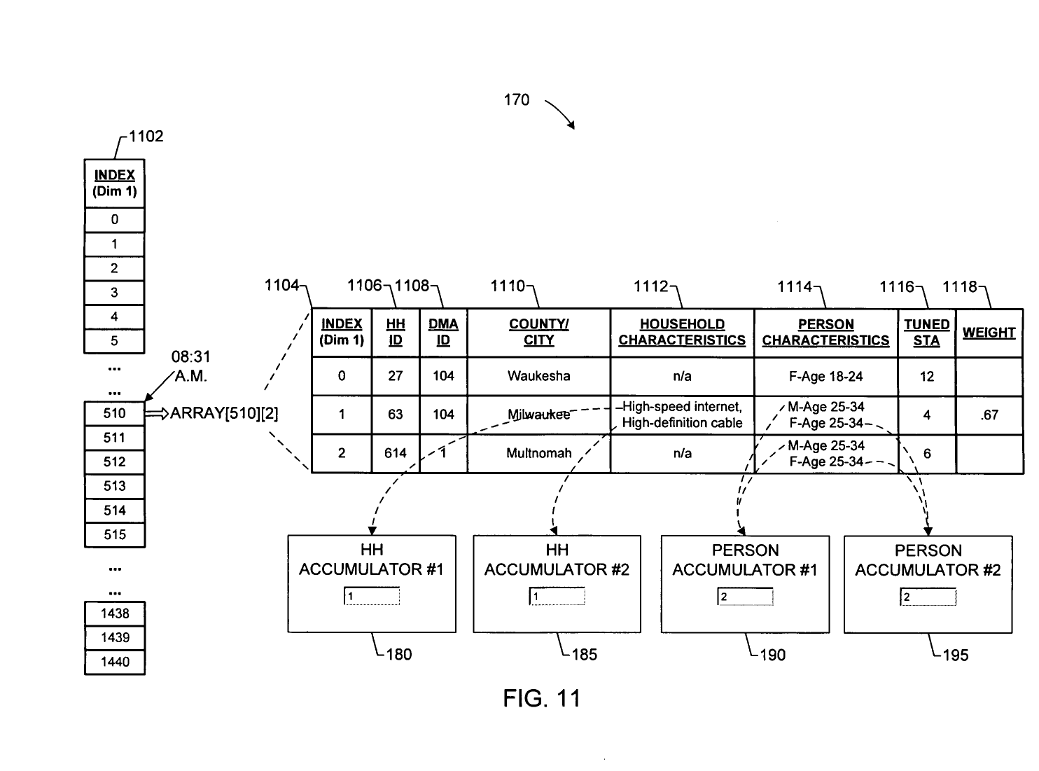

FIG. 11 illustrates an example aggregate array 170 that is generated by the estimation engine 145 based on the extracted viewership information stored in the characteristics arrays (150, 155, 160). In the illustrated example of FIG. 11, the aggregate array 170 includes a first dimension 1102 with index values ranging from 0 to 1440, which correspond to each minute within a 24-hour period. As described above, index values may be derived from any given hour and minute of the day by using Equation 1. Each first dimension index value points to a second dimension 1104 that is n elements in length, in which the value of n corresponds to the number of individual households from one or more of the characteristics arrays (150, 155, 160) that include characteristics of interest, as identified by the user via the example GUI 700 of FIG. 7. The example second array dimension 1104 of FIG. 11 includes an HH ID field 1106 to identify a unique household identifier within the viewing audience, a DMA ID field 1108 to identify a DMA identifier that corresponds to the household identifier, and a county or city identifier 1110 to specify additional geographic detail within the identified DMA. Additionally, the example second array dimension 1104 includes a household characteristics field 1112, a person characteristics field 1114, a tuned station field 1116, and a weight field 1118. In the illustrated example household characteristics field 1112 and person characteristics field 1114 of FIG. 11, one or more characteristic values are listed as comma separated values for purposes of example and not limitation. Additionally or alternatively, the example second array dimension 1104 of each corresponding first dimension 1102 index value may include multiple household and/or person characteristic column(s) to accommodate one or more characteristic values.

In operation, the example estimation engine 145 executes a loop starting with a first dimension 1102 index value that corresponds to the selected start-time (e.g., 510). Starting with, for example, the geography characteristics array 150, the estimation engine 145 extracts the household identifier 906, corresponding household characteristics value(s) (908, 910), and corresponding weighting values 912, and places such values in the household characteristics field 1112 of the aggregate array 170. To illustrate, the example geography characteristics array 150 of FIG. 8 includes, at the first dimension index value of “510” (i.e., 8:31 A.M.), a household identifier “27” that is associated with DMA “104.” Additionally, because each DMA may include any number of counties and/or cities therein, the example geography characteristics array 150 also indicates that the household associated with identifier “27” is located in the county of “Waukesha.” Upon completing a transfer of viewership data from the geography characteristics array 150 to the aggregate array 170 at the start-time first dimension 1102 index value, the example estimation engine 145 iterates to the next first dimension 1102 index value. Any viewership data located in the geography characteristics array 150 at the following index value is transferred in a manner similar to that described above.

However, when the example estimation engine 145 encounters a first dimension 1102 index value containing a null character, which indicates that the iteration may stop, the estimation engine 145 proceeds to transfer data from the household characteristics array 155 to the aggregate array 170. Similar to the transfer process described above in view of the geography characteristics array 150, the transfer of viewership data from the household characteristics array 155 includes iterating from the start-time index value (e.g., 510) through the stop-time index value (e.g., 514). To illustrate, the example household characteristics array 155 of FIG. 9 includes only one household with characteristics that match the user's request in the example GUI 700 (i.e., households having both high speed internet access and high-definition cable services). As a result, the second dimension 1104 of the example aggregate array 170 is populated with household characteristics 1112 only at the household (i.e., “63”) meeting the characteristics of interest. Additionally, the example households corresponding to identifiers “27” and “614” include an indicator that the household characteristics of interest were not present therein (“n/a”). When the example estimation engine 145 completes transfer of the first dimension index value that corresponds with the stop-time (e.g., index 514 corresponding to 8:34 A.M.), the estimation engine 145 returns to the start-time index value (e.g., 510) and proceeds to transfer data from the persons characteristics array 160 to the aggregate array 170.

The example aggregate array 170 enables a user to identify the number of households that match all characteristics of interest that were identified via the example GUI 700. While the example aggregate array 170 of FIG. 11 illustrates a relatively short span of time and a small number of households matching the characteristics of interest, such results are for demonstrative purposes and not to be construed as a limitation. In some examples, the span of time may be any value, such as the full index range from 0 to 1440 (i.e., 12:01 A.M. to 12:00 A.M.) and/or the number of households matching one or more characteristics of interest, as requested via the example GUI 700, may be greater or less than the three example results shown in FIG. 11.

To facilitate the user's ability to determine results of the query in a more efficient and/or summarized manner, the example audience estimator 120 generates and/or allocates one or more accumulators based on the GUI input(s). In particular, the accumulator engine 175 of the example audience estimator 120 generates one accumulator for each characteristic of interest identified by the user. In operation, if four characteristics of interest are identified, then the accumulator engine 175 generates four accumulators, one for each corresponding characteristic of interest. For example, if the characteristics of interest include households with high-speed internet, households with high-definition cable services, households with females age 25-34, and households with males age 25-34, then the accumulator engine 175 will generate a corresponding accumulator for each. For purposes of illustrating such example accumulators, the illustrated example of FIG. 2 includes: the first household characteristics accumulator 180 that may be associated with accumulating an occurrence of households with high-speed internet; the second household characteristics accumulator 185 that may be associated with accumulating an occurrence of households with high-definition cable services; the first person characteristic accumulator 190 that may be associated with accumulating an occurrence of households with at least one member that is female and between the ages of 25-34, and the second person characteristic accumulator 195 that may be associated with accumulating an occurrence of households with at least one member that is male and between the ages of 25-34.

The example accumulator engine 175 iterates through the aggregate array 170 starting at the start-time index (e.g., 510) and parsing the array 170 for instances of each characteristic associated with an accumulator (180, 185, 190, 195). Turning briefly to FIG. 11, the accumulator engine 175 begins at the first index value (“0”) of the second dimension 1104 and parses all fields of the corresponding index row. In the illustrated example index row “0” of the second dimension 1104, the accumulator engine 175 does not increment the first person accumulator 190 or the second person accumulator 195 because neither males nor females between the ages of 25-34 reside within the associated household. Similarly, the example accumulator engine 175 does not increment the first or second household accumulators because the household associated with index value “0” includes neither high-speed internet nor high-definition cable services. However, the accumulator engine 175, when finished parsing the first index (index element “0”), increments all four example accumulators when parsing the second index (index element “0”) of the second dimension 1104. In particular, because the household associated with the second index (household “63”) includes characteristics of high-speed internet, high-definition cable services, and males and females between the ages of 25-34, all four accumulators are incremented to reflect that such characteristics have been observed in households during the selected time frame (e.g., the timeframe between 8:31 A.M. and 8:34 A.M.).

As shown in FIG. 11, after the example estimation engine 175 iterates through first dimension index “510” and all associated second dimension 1104 indicies therein, the accumulated total for the first household characteristics accumulator 180 is “1,” the accumulated total for the second household characteristics accumulator 185 is “1,” the accumulated total for the first person characteristics accumulator 190 is “2,” and the accumulated total for the second person characteristics accumulator 195 is also “2.” To that end, the example accumulators continue to increment when corresponding characteristics are detected by the accumulator engine 175 as the aggregate array 170 is parsed through all of the second dimension 1104 indicies for all of the corresponding first dimension 1102 indicies within the start-time and stop-time limits.

Flowcharts representative of example machine readable instructions for implementing any of the example systems of FIGS. 1 and 2 to calculate audience measurements are shown in FIGS. 12-16. In this example, the machine readable instructions comprise a program for execution by: (a) a processor such as the processor 1712 shown in the example computer 1700 discussed below in connection with FIG. 17, (b) a controller, and/or (c) any other suitable processing device. The program may be embodied in software stored on a tangible medium such as, for example, a flash memory, a CD-ROM, a floppy disk, a hard drive, a digital versatile disk (DVD), or a memory associated with the processor 1712, but the entire program and/or parts thereof could alternatively be executed by a device other than the processor 1712 and/or embodied in firmware or dedicated hardware (e.g., it may be implemented by an application specific integrated circuit (ASIC), a programmable logic device (PLD), a field programmable logic device (FPLD), discrete logic, etc.). Thus, for example, any of the example audience estimator 120, the example XML generator 130, the example estimation engine 145, and/or the example accumulation engine 175 could be implemented by one or more circuit(s), programmable processor(s), ASIC(s), PLD(s) and/or FPLD(s), etc. When any of the appended claims are read to cover a purely software implementation, at least one of the example audience estimator 120, the example XML generator 130, the example estimation engine 145, and/or the example accumulation engine 175 are hereby expressly defined to include a tangible medium such as a memory, DVD, CD, etc.

Also, some or all of the machine readable instructions represented by the flowcharts of FIGS. 12-16 may be implemented manually. Further, although the example program is described with reference to the flowcharts illustrated in FIGS. 12-16, many other methods of implementing the example machine readable instructions may alternatively be used. For example, the order of execution of the blocks may be changed, and/or some of the blocks described may be changed, substituted, eliminated, or combined.

FIG. 12 is a flowchart representative of machine readable instructions 1200 that may be executed to calculate audience estimations. The process 1200 of FIG. 12 begins at block 1202 where the example audience estimator 120 builds the daily observation array 125. In some examples, the daily observation array 125 may be archived and/or stored for later analysis of viewership behavior(s) including, but not limited to, comparisons of viewership behavior(s) on a day-to-day basis, comparisons of viewership behavior(s) based on seasonal differences, and/or comparisons of viewership behavior(s) on an annual and/or other time basis to ascertain one or more demographic changes within the viewership audience 103.

One or more XML files 135 are built (block 1204) based on the viewership data contained within the example observation array 125. Additionally, the XML generator 130 provides such XML files 135 to the estimation engine 145 to allow a GUI to be built (block 1206) that constrains user queries based on available viewership characteristics. Depending on the one or more viewership characteristics selected for a query, one or more characteristics arrays are built (block 1208). Furthermore, construction of the one or more characteristics arrays enables the aggregate array 170 to be constructed. Based on the selected characteristics of interest to the user, as identified via the example GUI 140, the accumulator engine 175 allocates and/or generates corresponding accumulators (block 1210). As the accumulator engine parses the aggregate array 170, detected instances of such characteristics result in the one or more accumulators incrementing, thereby providing the user with an understanding of which stations are being viewed by viewers having the corresponding characteristics.

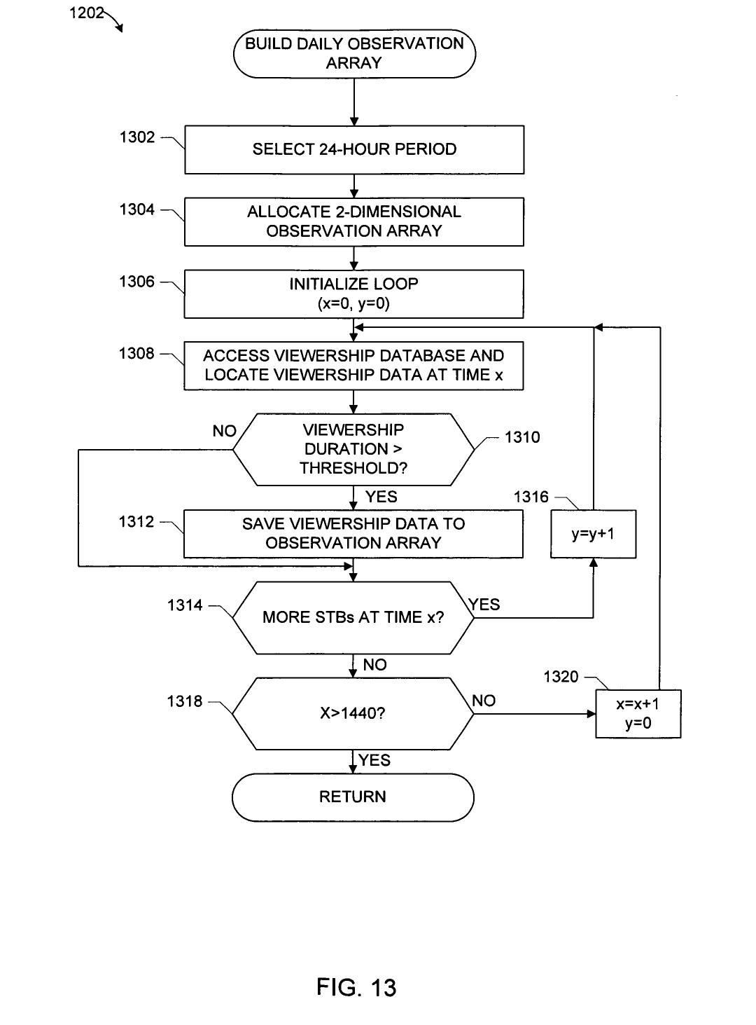

FIG. 13 illustrates additional detail of construction of the daily observation array (block 1202) described above. In the illustrated example, the XML generator 130 selects a 24-hour period of interest (block 1302) to extract from the viewership database 115. The 24-hour period of interest may be, but is not limited to, the previous day's worth of viewership data that has been stored in the viewership database 115. The XML generator 130 allocates and/or constructs the example observation array 125 as a two-dimensional array, in which the first-dimension includes element indicies ranging from 0 to 1440 (block 1304). As described above, Equation 1 allows each array element to correspond to exactly one minute of each 24-hour day. Prior to extracting viewership data from the viewership database 115 for a selected day, the example XML generator 130 prepares a nested loop. In one example loop, the example XML generator 130 initializes variables x and y to zero, in which the x variable loops from 0 to 1440 through the first-dimension and they variable tracks the length and/or depth of the second-dimension of the example observation array 125 (block 1306).

The viewership database 115 is accessed by the XML generator 130 to locate viewership data associated with the first-dimension index value, which is a representation in time for referring to the timestamp (e.g., columns 302a-c of FIG. 3) of the viewership database 115 (block 1308). For example, the XML generator 130 translates an index value (e.g., index value 500) into a corresponding time-of-day (e.g., 8:20 A.M.). However, prior to extracting the viewership data from the viewership database 115 and saving it to the observation array 125, the example XML generator 130 determines whether the viewership data at the current index has endured, or will endure a threshold amount of uninterrupted viewing (block 1310). For example, a media researcher may not find useful viewership data indicative of channel hopping or surfing during relatively short periods of time. To that end, the media researcher may prefer a threshold of five continuous minutes for which a channel in the household does not change. If five continuous minutes of viewing occurs without a station/channel change (block 1310), then the corresponding viewership data is saved to the observation array 125 (block 1312), otherwise the data is not saved. In either case, the process 1202 determines whether additional STBs exist in the viewership database 115 at the time associated with index value x (block 1314). If so, then the second-dimension index (y) is incremented (block 1316) and control returns to block 1308. However, if no further STBs have viewership data for the time associated with the first-dimension index (x), then the STB generator 130 determines whether all minutes within the 24-hour period of interest have been parsed (block 1318). If not, then the first-dimension index is incremented by one and the second-dimension index is reset to zero (block 1320) and control returns to block 1308.

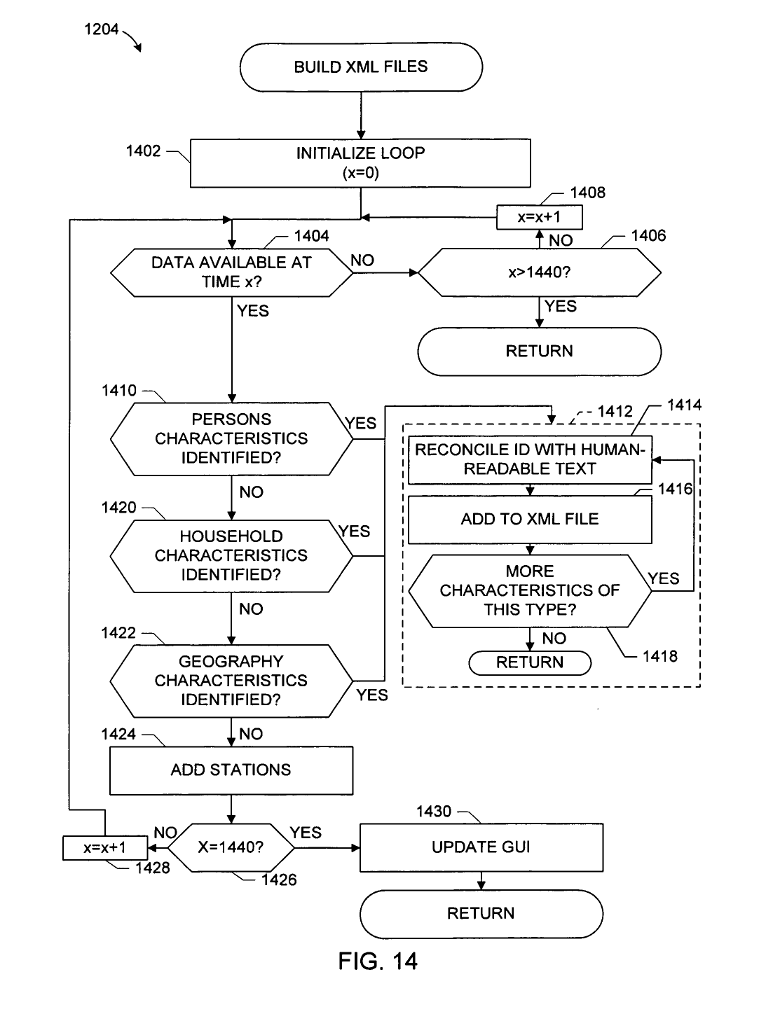

Upon completion of building the example observation array 125, the example XML generator 130 constructs the XML files 135 (block 1204), as shown in further detail in FIG. 14. In the illustrated example, the XML generator 130 initializes a loop to iterate through all 1441 elements in the first-dimension of the observation array (block 1402). The XML generator 130 determines whether any viewership data is available at the current first-dimension index value (x) (block 1404). In the event that the observation array 125 does not contain any data for the first-dimension index value, the XML generator 130 determines whether the end of the first-dimension index has been reached (block 1406) and, if so, returns control to block 1206, described in further detail below. On the other hand, if the end of the first-dimension index has not been reached yet (i.e., index x is not greater than or equal to 1440) (block 1406), then the index value is incremented by one (block 1408) and control returns to block 1404.

In the event that viewership data is available in the observation array 125 at the index value (x) (block 1404), then the XML generator 130 determines whether the detected viewership data is associated with person characteristics (block 1410). If the detected viewership data is associated with person characteristics (block 1410), then the XML generator 130 employs a reconciliation process 1412 that reconciles the identifier with human-readable text (block 1414), writes the human readable text to the XML files 135 (block 1416), and determines whether additional identifiers are available to reconcile (block 1418). If so, then control returns to block 1414. As described above, reconciliation converts a memory efficient numerical representation of an array to human-readable information or indicia. Such reconciliation/conversion employs the example global data structures 165 that include one or more look-up reference arrays (166, 167, 168).

If no further characteristic identifiers are found (block 1418), the example reconciliation process 1412 returns control back to the calling routine (i.e., in this example block 1410 called block 1412). Control advances to block 1420 where the example XML generator 130 determines whether detected viewership data is associated with household characteristic identifiers. If so, then control advances to the reconciliation process 1412 in a manner as described above, otherwise control advances to block 1422 where the example XML generator 130 determines whether detected viewership data is associated with geographic characteristic identifiers. Again, if characteristic identifiers are detected, such as a numeric value of “104” in a DMA field of the observation array 125 and a numeric value of “27” in a household identifier field of the observation array 125, then the example reconciliation process 1412 accesses the appropriate reference arrays within the global data structures 165 to convert the DMA/HH ID combination into the human readable text “Waukesha.”

Similarly, the example XML generator 130 determines whether the detected viewership data identifies particular stations (block 1424) and adds such stations to the XML files 135 so that the user may select one or more stations as a characteristic of interest prior to a query of the daily viewership data.

If the first-dimension index value (x) is not equal to the maximum value of 1440 (block 1426), then the index value (x) is incremented by one (block 1428) and control returns to block 1404. On the other hand, if the index value (x) is equal to 1440, the XML file creation is complete and the GUI 140 is updated to reflect the one or more characteristics from which the user may choose when performing a query of viewership data (block 1430).

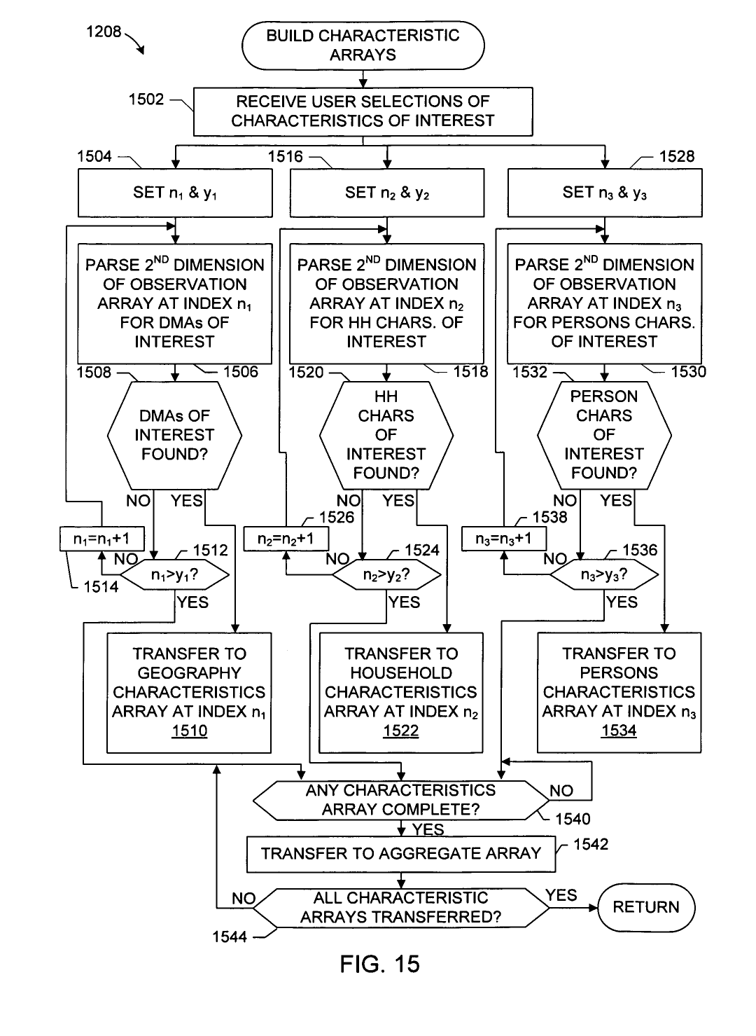

FIG. 15 illustrates additional detail for building characteristics arrays (block 1208) after the user has selected one or more characteristics of interest, such as the example characteristics of interest shown in the example GUI 700 of FIG. 7. In the illustrated example of FIG. 15, the estimation engine 145 receives selections from the user that identify one or more characteristics of interest (block 1502). Based on the particular characteristics of interest selected by the user, the example estimation engine 145 generates a corresponding geography characteristics array 150 (blocks 1504 through 1514), a corresponding household characteristics array 155 (blocks 1516 through 1526), and/or a corresponding persons characteristics array 160 (blocks 1528 through 1538). To maximize user query turn-around time, the aforementioned arrays (150, 155, 160) may be generated by the estimation engine 145 and/or one or more processors in a parallel manner.

The example geography characteristics array 150 is created by initializing a current index value n₁ to a value that corresponds to the selected start-time, and initializing a stopping index value y₁ that corresponds to the selected stop-time (block 1504). The estimation engine 145 parses the DMA ID field of the second-dimension of the observation array at the current index value (n₁) to detect a DMA of interest selected by the user (block 1506). If a corresponding DMA of interest is detected (block 1508), then the example estimation engine 145 transfers that DMA value and corresponding household identifier value (HH ID value), corresponding county/city information, and the station value to the geography characteristics array 150 (block 1510). Such transferred information is placed at the current index value (n₁) of the geography characteristics array 150. The estimation engine 145 then determines whether the current index value (n₁) is greater than or equal to the stopping index value (y₁) (block 1512). If not, then the current index value (n₁) is incremented by one (block 1514) and control advances to block 1506. On the other hand, if the current index value (n₁) has reached the end (the stopping index value), then control advances to block 1540, as discussed in further detail below.

In a manner similar to creation of the example geography characteristics array 150 described above, the example household characteristics array 155 is created by initializing a current index value n₂ to a value that corresponds to the selected start-time, and initializing a stopping index value y₂ that corresponds to the selected stop-time (block 1516). The estimation engine 145 parses the HH ID field of the second-dimension of the observation array at the current index value (n₂) to cross reference the household characteristics reference array 166 and detect one or more household characteristics of interest selected by the user (block 1518). If a corresponding household characteristic of interest is detected (block 1520), then the example estimation engine 145 transfers that HH ID value, weight, and corresponding household characteristics to the household characteristics array 155 (block 1522). Such transferred information is placed at the current index value (n₂) of the household characteristics array 155. The estimation engine 145 then determines whether the current index value (n₂) is greater than or equal to the stopping index value (y₂) (block 1524). If not, then the current index value (n₂) is incremented by one (block 1526) and control advances to block 1518. On the other hand, if the current index value (n₂) has reached the end (the stopping index value), then control advances to block 1540, as discussed in further detail below.

In a manner similar to creation of the example geography characteristics array 150 and creation of the example household characteristics array 155 described above, the example persons characteristics array 160 is created by initializing a current index value n₃ to a value that corresponds to the selected start-time, and initializing a stopping index value y₃ that corresponds to the selected stop-time (block 1528). The estimation engine 145 parses the PERSON field of the second-dimension of the observation array at the current index value (n₃) to cross-reference the persons characteristics reference array 167 and detect one or more persons characteristics of interest selected by the user (block 1530). If a corresponding person characteristic of interest is detected (block 1532), then the example estimation engine 145 transfers the corresponding sex and age information to the persons characteristics array 160 (block 1534). Such transferred information is placed at the current index value (n₃) of the persons characteristics array 160. The estimation engine 145 then determines whether the current index value (n₃) is greater than or equal to the stopping index value (y₃) (block 1536). If not, then the current index value (n₃) is incremented by one (block 1538) and control advances to block 1530. On the other hand, if the current index value (n₃) has reached the end (the stopping index value), then control advances to block 1540 where it is determined whether any of the characteristics arrays are complete.

Rather than wait for all three of the characteristics arrays 150, 155, 160 to complete construction, when any of the characteristics arrays are complete (block 1540), the example estimation engine 145 may transfer the contents of any completed characteristics array to the aggregate array 170 while one or more other characteristics arrays are still being built (block 1542). The estimation engine 145 determines whether all of the characteristics array contents have been transferred to the aggregate array 170 (block 1544) and, if not, control returns to block 1540 to wait for build completion of any remaining array(s).

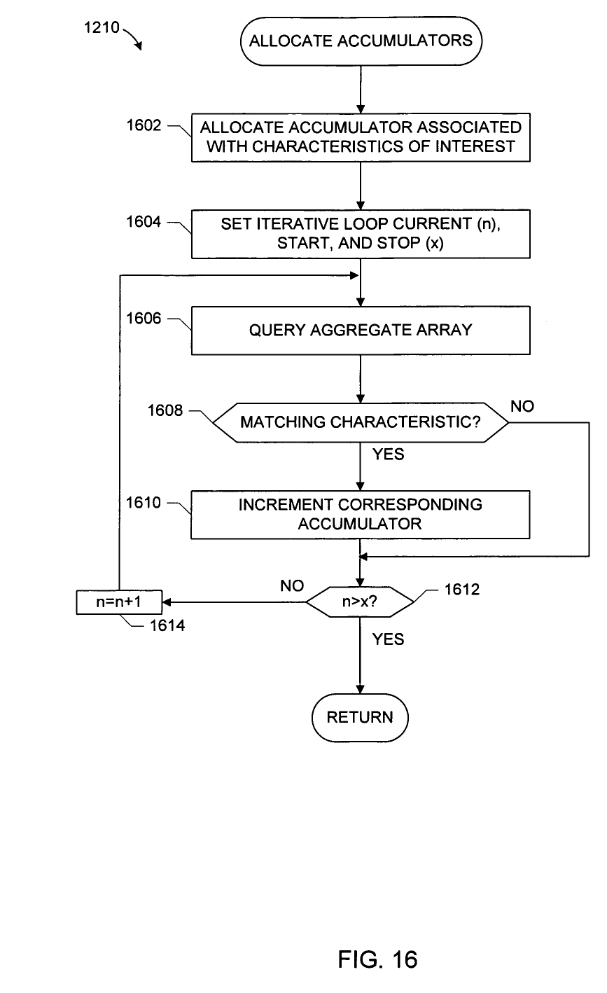

FIG. 16 illustrates additional detail for allocating and iterating the example accumulators (block 1210) after the example aggregate array 170 is constructed and populated with the viewership information contained within the characteristics arrays (150, 155, 160). In the illustrated example of FIG. 16, the accumulator engine 175 allocates an accumulator for each characteristic of interest that was selected by the user via the GUI 140, such as the example GUI 700 of FIG. 7 (block 1602). Generally speaking, each accumulator associated with a characteristic of interest, such as, for example, households having high-definition television service, serves as an indicator to the user of how frequently such characteristic(s) occur during a selected time period of interest. Additionally, the user may gain further insight related to the frequency of one or more characteristics of interest occurring in one or more combinations with other characteristics of interest.

Prior to incrementing one of the accumulators that correspond to a selected characteristics of interest, the example accumulator engine 175 sets variables for an iterative loop (block 1604). In one example iterative loop, a current index value n is set equal to a starting index value that corresponds to one of the 1441 index values in the aggregate array 170. As such, the accumulator engine 175 may begin analysis of the aggregate array 170 at a point known to include relevant viewership information, and no processing time need be consumed iterating through index values that are void of viewership data. The accumulator engine 175 parses the aggregate array 170 at the current index value (n) (block 1606) and determines if one of the characteristics of interest is present (e.g., a household having high-definition cable television service) (block 1608). If so, the corresponding accumulator is incremented (block 1610), otherwise the accumulator engine 175 determines whether the current index value (n) is greater than or equal to the stop-time index value (block 1612). If the stop-time index value has not yet been reached, then the current index value (n) is incremented by one (block 1614) and control returns to block 1606.

FIG. 17 is a block diagram of an example processor system that may be used to execute the example machine readable instructions of FIGS. 12-16 to implement the example systems and/or methods described herein. As shown in FIG. 17, the processor system 1710 includes a processor 1712 that is coupled to an interconnection bus 1714. The processor 1712 includes a register set or register space 1716, which is depicted in FIG. 17 as being entirely on-chip, but which could alternatively be located entirely or partially off-chip and directly coupled to the processor 1712 via dedicated electrical connections and/or via the interconnection bus 1714. The processor 1712 may be any suitable processor, processing unit or microprocessor. Although not shown in FIG. 17, the system 1710 may be a multi-processor system and, thus, may include one or more additional processors that are identical or similar to the processor 1712 and that are communicatively coupled to the interconnection bus 1714.

The processor 1712 of FIG. 17 is coupled to a chipset 1718, which includes a memory controller 1720 and an input/output (I/O) controller 1722. A chipset typically provides I/O and memory management functions as well as a plurality of general purpose and/or special purpose registers, timers, etc. that are accessible or used by one or more processors coupled to the chipset 1718. The memory controller 1720 performs functions that enable the processor 1712 (or processors if there are multiple processors) to access a system memory 1724 and a mass storage memory 1725.

The system memory 1724 may include any desired type of volatile and/or non-volatile memory such as, for example, static random access memory (SRAM), dynamic random access memory (DRAM), flash memory, read-only memory (ROM), etc. The mass storage memory 1725 may include any desired type of mass storage device including hard disk drives, optical drives, tape storage devices, etc.

The I/O controller 1722 performs functions that enable the processor 1712 to communicate with peripheral input/output (I/O) devices 1726 and 1728 and a network interface 1730 via an I/O bus 1732. The I/O devices 1726 and 1728 may be any desired type of I/O device such as, for example, a keyboard, a video display or monitor, a mouse, etc. The network interface 1730 may be, for example, an Ethernet device, an asynchronous transfer mode (ATM) device, an 802.11 device, a digital subscriber line (DSL) modem, a cable modem, a cellular modem, etc. that enables the processor system 1710 to communicate with another processor system.

While the memory controller 1720 and the I/O controller 1722 are depicted in FIG. 17 as separate functional blocks within the chipset 1718, the functions performed by these blocks may be integrated within a single semiconductor circuit or may be implemented using two or more separate integrated circuits.

Although certain methods, apparatus, systems, and articles of manufacture have been described herein, the scope of coverage of this patent is not limited thereto. To the contrary, this patent covers all methods, apparatus, systems, and articles of manufacture fairly falling within the scope of the appended claims either literally or under the doctrine of equivalents.

1. A method to analyze viewership information comprising:
identifying a subset of stored viewership data;
allocating an observation array having a first-dimension index, each indicie of the index associated with one time-period of at least one household datapoint in the subset of stored viewership data;
transferring the identified subset to the observation array;
building an extensible markup language (XML) file based on at least one detected characteristic in the observation array; and
generating a graphical user interface (GUI) based on the XML file for use with at least one query selection associated with the at least one detected characteristic.

2. A method as defined in claim 1, further comprising allocating at least one characteristics array and transferring viewership information from the observation array to a second-dimension of the characteristics array, the viewership information associated with the at least one query selection.

3. A method as defined in claim 2, wherein the at least one characteristics array comprises at least one of a persons-characteristics array, a household-characteristics array, or a geographic-characteristics array.

4. A method as defined in claim 3, wherein the persons-characteristics array comprises viewership information associated with at least one of age, sex, or ethnicity.

5. A method as defined in claim 3, wherein the household-characteristics array comprises viewership information associated with at least one of household audio equipment, household video equipment, household internet capabilities, or household income.

6. A method as defined in claim 3, wherein the geography-characteristics array comprises viewership information associated with at least one of a designated market area, a county, or a city.

7. A method as defined in claim 2, further comprising consolidating the viewership information of the at least one characteristics array to an aggregate array, the aggregate array comprising a first-dimension index corresponding to the first-dimension index of the observation array.

8. A method as defined in claim 7, wherein consolidating the viewership information further comprises:
identifying a start-time of interest;
extracting the viewership information from the at least one characteristics array corresponding to the start-time; and
transferring the viewership information to the aggregate array at an indicie of the first-dimension index corresponding to the start-time.

9. A method as defined in claim 8, wherein the viewership information is transferred to a second-dimension of the aggregate array.

10. A method as defined in claim 7, further comprising allocating an accumulator for each of the at least one query selections.

11. A method as defined in claim 10, further comprising:
iterating through the first-dimension index of the aggregate array;
detecting an instance of the at least one query selection; and
incrementing an accumulator associated with the at least one query selection.

12. A method as defined in claim 1, wherein the subset of stored viewership data comprises a twenty-four hour period of viewership data.

13. A method as defined in claim 1, wherein allocating the first-dimension index of the observation array comprises associating each indicie with one minute in a twenty-four hour period.

14. A method as defined in claim 13, wherein the first-dimension index is 1441 indicies in length.

15. A method as defined in claim 1, wherein the GUI constrains the user to select only the at least one detected characteristic.

16. A method as defined in claim 1, wherein transferring the identified subset to the observation array further comprises filtering household datapoints that satisfy a viewership threshold.

17. A method as defined in claim 16, wherein the viewership threshold comprises a minimum number of consecutive minutes of same-station viewing time.

18. A method as defined in claim 1, wherein the observation array comprises at least one numerical identifier corresponding to the at least one characteristic.

19. A method as defined in claim 18, wherein building the XML file further comprises reconciling the at least one numerical identifier with a data structure to obtain human-readable information.

20. An apparatus to analyze viewership information comprising:
a viewership database to store viewership information associated with a plurality of households;
an extensible markup language (XML) generator to transfer a portion of the viewership information to an observation array and generate an XML file indicative of viewership characteristics detected in the observation array; and
an estimation engine to build a graphical user interface (GUI) based on a viewership characteristic detected in the observation array.

21. An apparatus as defined in claim 20, further comprising at least one characteristics array to store a subset of viewership data unique to one of the viewership characteristics detected within the observation array.

22. An apparatus as defined in claim 21, wherein the at least one characteristics array comprises at least one of a geography-characteristics array, a household-characteristics array, or a persons-characteristics array.

23. An apparatus as defined in claim 21, further comprising a data structure to translate numerical representations of the viewership characteristics to human-readable representations of the viewership characteristics.

24. An apparatus as defined in claim 23, wherein the data structure further comprises at least one of a household-characteristics reference array, a persons-characteristics reference array, or a geography reference array.

25. An apparatus as defined in claim 21, further comprising an aggregate array to store the viewership characteristics associated with the at least one characteristics array.

26. An apparatus as defined in claim 25, further comprising an accumulator engine to allocate at least one accumulator associated with each selected viewership characteristic, the accumulator engine to parse the aggregate array for an instance of each of the selected viewership characteristics and increment the at least one accumulator in response thereto.

27. An article of manufacture storing machine readable instructions which, when executed, cause the machine to:
identify a subset of stored viewership data;
allocate an observation array having a first-dimension index, each indicie of the index associated with one time-period of at least one household datapoint in the subset of stored viewership data;
transfer the identified subset to the observation array;
build an extensible markup language (XML) file based on at least one detected characteristic in the observation array; and
generate a graphical user interface (GUI) based on the XML file for use with at least one query selection associated with the at least one detected characteristic.

28. (canceled)

29. (canceled)

30. (canceled)

31. (canceled)

32. (canceled)

33. (canceled)

34. (canceled)

35. (canceled)

36. (canceled)
